(19) United States
(12) Patent Application Publication
(10) Pub. No.: US 2026/0087619 A1
(43) Pub. Date: Mar. 26, 2026

(54) Automating Ultrasound eFAST Triage Using Artificial Intelligent Models

(71) Applicant: The Government of The United States, as represented by The Director of the Defense Health Agency, Fort Detrick, MD (US)

(72) Inventors: Eric J. Snider, San Antonio, TX (US); Sofia I. Hernández Torres, San Antonio, TX (US)

(73) Assignee: The Government of The United States, as represented by The Director of the Defense Health Agency, Fort Detrick, MD (US)

(21) Appl. No.: 19/307,654

(22) Filed: Aug. 22, 2025

Related U.S. Application Data
(60) Provisional application No. 63/686,836, filed on Aug. 25, 2024.
(60) Provisional application No. 63/686,839, filed on Aug. 25, 2024.

(51) Int. Cl. G06T 7/00; G06V 10/75; G06V 10/774; G06V 10/776

(52) U.S. Cl. CPC G06T 7/0012; G06V 10/758; G06V 10/7747; G06V 10/776; G06T 2207/10132; G06T 2207/20081; G06T 2207/30061; G06V 2201/033

(57) ABSTRACT

A method and non-transitory computer-readable medium for automating eFAST analysis of ultrasound scans. The method includes receiving at least one ultrasound image from one or more scan sites; processing the ultrasound image to determine whether there is a presence of one or more fluid pockets or free fluid present in the patient, the injury is selected from pneumothorax, hemothorax, and abdominal hemorrhage; and outputting a result from the processing. A model is trained on historical ultrasound images over a historical observation period, the historical ultrasound images associated with at least one injury determined directly observed presence of a fluid pocket or free fluid present in those images.

### PRIORITY CLAIM

This application claims the benefit of provisional application Ser. No. 63/686,836 filed Aug. 25, 2024 and titled “Automating Ultrasound eFAST Triage Using Artificial Intelligent Models” and provisional application Ser. No. 63/686,839 filed Aug. 25, 2024 and titled “Automating Ultrasound Image Capture Platform Using Robotics and Artificial Intelligence for eFAST Triage Procedures” the entire contents of which are hereby incorporated by reference.

### STATEMENT OF GOVERNMENT INTEREST

The invention described herein may be manufactured, used and licensed by or for the United States Government.

### BACKGROUND

During trauma situations, it is common for medical care personnel to utilize triage procedures to characterize casualties or wounded patients to effectively distribute the appropriate level of care for each patient. This is particularly relevant in combat casualty care as mass casualty situations require rapid triage and are anticipated on the future battlefield. This is further complicated by a challenged airspace, for example, that will require prolonged field care in the battlefield of up to 72 hours as has been common during recent conflicts.

Medical imaging is a commonly used tool for triage as it allows to examine internal injuries that may not be apparent. Moreover, recent improvements have made it an important injury assessment tool in emergency situations in which triaging of injuries and the quick treatment of injuries can determine whether a life is saved or lost. Ultrasound (US), in particular, is effective in modern military and emergency medicine. In addition to being relatively low in cost and portable, it is useful for its ability in detecting free fluid, which is synonymous with injury in the thoracic and abdominal cavities. This is effective because assessments can be made while patients are being transported, or when they need to be examined swiftly in the field. For triage, having tools outside of a definitive healthcare setting is crucial for administering different imaging procedures. This helps mitigate the devastating effect of emergency situations, which are prone to high fatality rates when there is no immediate access to structured, hospital care.

One specific medical imaging-based triage application in military medicine is the extended Focused Assessment with Sonography for Trauma (eFAST) which can reliably assess for free fluid or air in the abdominal and thoracic cavities, indicative of pneumothorax, hemothorax, or abdominal hemorrhage injuries. The eFAST exam uses ultrasound imaging to scan the thorax and abdomen for free fluid for injury diagnosis. The eFAST exam is accordingly a point-of-care method of examination that non-invasively evaluates the thoracic and abdominal cavities for the presence of free fluid or air in order to identify abdominal hemorrhage (AH), hemothorax (HTX), and pneumothorax (PTX).

One advantage of the eFAST exam is that it uses ultrasound equipment which can be portable, has a lower power requirement, and is more affordable compared to other medical imaging approaches, giving eFAST considerable availability at or near the point of injury. As such, eFAST can allow for rapid triage in a pre-hospital or combat casualty care setting.

While eFAST procedures are commonly used, there are several aspects that should be taken into consideration in using and administering an eFAST exam. A primary challenge is that the procedure depends on the availability of trained ultrasound technicians that are needed for proper image acquisition, interpretation and triage decisions. Being able to properly use US equipment can be technically challenging for less-experienced personnel, as proper angles and positionings of the US transducer are required to identify the regions where fluid and air are most often pooled in the abdominal and thoracic cavities. Second, correctly identifying injury at the scan site is technically challenging, requiring an interpretation of anatomical landmarks and the identification of variable volumes of free fluid or air. Unfortunately, there is a projected shortage of medical providers that can properly perform and interpret injury from a US exam, which will be especially detrimental in mass casualty situations.

In an extended emergency trauma or mass casualty situation, it is anticipated that there will be shortages of medical personnel that can perform an eFAST scan and make a diagnosis. The longer it takes for a wounded soldier to be medically evaluated and transported to a higher echelon of care or treatment, the greater the logistical burden and strain on resources becomes, thus making it more difficult to effectively triage. While less trained personnel could perform an eFAST exam, the diagnoses are only as good as the images captured, and there is subjectivity variance in diagnostic accuracy between sonographers. Given the urgency of identifying trauma in an efficient manner can lead to this diagnostic bias when making triage decisions.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings provide visual representations which will be used to describe various representative embodiments more fully and can be used by those skilled in the art to better understand the representative embodiments disclosed and their inherent advantages. In these drawings, like reference numerals identify corresponding or analogous elements.

FIG. 1 illustrates overview of eFAST scan sites, in accordance with various embodiments of the present disclosure.

FIG. 2 illustrates representative ultrasound images for each scan point. Each column shows ultrasound images at the different scan points for negative (top) or positive (bottom) injury state, in accordance with various embodiments of the present disclosure.

FIG. 3 illustrates a flowchart of architecture optimization pipeline, in accordance with various embodiments of the present disclosure.

FIG. 4 illustrates an overview of the LOSO method as applied to swine ultrasound images, in accordance with various embodiments of the present disclosure.

FIGS. 5A-5D illustrates normalized performance score for the exhaustive optimization for each scan site, in accordance with various embodiments of the present disclosure.

FIGS. 6A-6E illustrate distribution of values across Bayesian optimization for each scan point and hyperparameter, in accordance with various embodiments of the present disclosure.

FIGS. 7A-7F illustrate prediction results from the LOSO training regimen for the RUQ scan site for different AI architectures, in accordance with various embodiments of the present disclosure.

FIGS. 8A-8F illustrate prediction results from the LOSO training regimen for the BLD scan site for different AI architectures, in accordance with various embodiments of the present disclosure.

FIGS. 9A-9F illustrate prediction results from the LOSO training regimen for the PTX_B scan site for different AI architectures, in accordance with various embodiments of the present disclosure.

FIGS. 10A-10F illustrate prediction results from the LOSO training regimen for the PTX_M scan site for different AI architectures in accordance with various embodiments of the present disclosure.

FIGS. 11A-11F illustrates prediction results, in accordance with various embodiments of the present disclosure.

FIGS. 12A-12F illustrate prediction results from the LOSO training regimen for the HTX_M scan site for different AI architectures, in accordance with various embodiments of the present disclosure.

FIG. 13 illustrates a chart of performance metrics of all models for PTX-M scan site, in accordance with various embodiments of the present disclosure.

FIG. 14 illustrates a diagram of confusion matrices and Gradient-weighted class activation mapping (GradCAM) overlays of MobileNetv2 inferencing, in accordance with various embodiments of the present disclosure.

FIG. 15 illustrates histograms comparing the contrast scores of images labeled poor and original sample dataset, in accordance with various embodiments of the present disclosure.

FIG. 16 illustrates a simple Diagram of model architecture for YOLO, in accordance with various embodiments of the present disclosure.

FIGS. 17A-B illustrate a demonstration of custom M-Mode slices created from B-Mode images, in accordance with various embodiments of the present disclosure.

FIG. 18 illustrates an ultrasound scan showing a rib, in accordance with various embodiments of the present disclosure.

FIG. 19 illustrates three classes, 5 second window size for a thoracic scan, in accordance with various embodiments of the present disclosure.

FIG. 20 illustrates a pair of abdominal ultrasound scans with RUQ/BLD guidance AI, in accordance with various embodiments of the present disclosure.

FIG. 21 illustrates a confusion matrix normalized, in accordance with various embodiments of the present disclosure.

FIG. 22 illustrates a confusion matrix normalized, in accordance with various embodiments of the present disclosure.

FIG. 23 provides an overview of animal study procedures and image capture timepoints, in accordance with various embodiments of the disclosure.

FIG. 24 provides an overview of ultrasound image dataset structure and processing for images captured in swine for eFAST AI model training, in accordance with various embodiments of the disclosure.

FIG. 25 provides an overview of AI model types, in which a summary of data flow for eFAST AI model training is shown, in accordance with various embodiments of the disclosure.

FIG. 26 provides an overview of how M-mode images were generated from B-mode frames using rib guidance AI models.

FIG. 27A, 27B illustrate an example graphical user interface, in accordance with various embodiments of the disclosure.

FIG. 28 provides an overview of an example robotic configuration for automated eFAST in swine, in accordance with various embodiments of the disclosure.

FIGS. 29A, 29B illustrate guidance AI performance for anatomical locations, in accordance with various embodiments of the disclosure.

FIGS. 30A, 30B, 30C, 30D illustrate diagnostic AI confusion matrices for each diagnostic model, in accordance with various embodiments of the disclosure.

FIGS. 31A, 31B, 31C illustrate an evaluation of a real-time eFAST application, in accordance with various embodiments of the disclosure.

FIGS. 32A, 32B, 32C, 32D illustrate performance evaluation in swine, in accordance with various embodiments of the disclosure.

FIGS. 33A, 33B illustrate RoboFAST thoracic US images, in accordance with various embodiments of the disclosure.

FIG. 34 illustrates a summary of eFAST image capture times, in accordance with various embodiments of the disclosure.

FIG. 35 illustrates a system block diagram including an example of a computing device that may be used in implementing one or more features of the disclosure, in accordance with embodiments of the present disclosure.

FIG. 36 shows representative motion mode (M-mode) US images of relevant thoracic region injury states, in accordance with embodiments of the present disclosure.

FIG. 37 is a block diagram summarizing study methods using during the thoracic study, in accordance with embodiments of the present disclosure.

FIG. 38 illustrates representative standardized metric scatter plot with corresponding US captures, in accordance with embodiments of the present disclosure.

FIGS. 39A, 39B, 39C illustrate standardized metric plots with pig labels, in accordance with embodiments of the present disclosure.

FIG. 40 illustrates plots of image metrics with corresponding confidence ellipse filter, in accordance with embodiments of the present disclosure.

FIG. 41 illustrates a balanced accuracy model performance plot, in accordance with embodiments of the present disclosure.

FIGS. 42A, 42B, 42C illustrate real-time performance visualization metrics, in accordance with embodiments of the present disclosure.

FIGS. 43A, 43B illustrate comparison of training and real-time accuracy for M-mode DL classification models, in accordance with embodiments of the present disclosure.

FIG. 44 provides blind test performance metric summary for each model architecture for the RUQ scan site, in accordance with embodiments of the present disclosure.

FIG. 45 provides blind test performance metric summary for each model architecture for the BLD scan site, in accordance with embodiments of the present disclosure.

FIG. 46 provides blind test performance metric summary for each model architecture for the PTX_B scan site, in accordance with embodiments of the present disclosure.

FIG. 47 provides blind test performance metric summary for each model architecture for the PTX_M scan site, in accordance with embodiments of the present disclosure.

FIG. 48 provides blind test performance metric summary for each model architecture for the HTX_B scan site, in accordance with embodiments of the present disclosure.

FIG. 49 provides blind test performance metric summary for each model architecture for the HTX_M scan site, in accordance with embodiments of the present disclosure.

### DETAILED DESCRIPTION

Medical imaging-based triage is an important tool for emergency medicine in both civilian and military settings. Ultrasound imaging can be used to rapidly identify free fluid in abdominal and thoracic cavities which could necessitate immediate surgical intervention. One specific application is the eFAST, where pneumothorax, hemothorax, or abdominal hemorrhage injuries are identified. However, the diagnostic accuracy of an eFAST exam depends on obtaining proper scans and making quick interpretation decisions to evacuate casualties or administer necessary interventions. Proper ultrasound image capture requires a skilled ultrasonography technician who is likely unavailable at the point of injury where resources are limited.

To improve ultrasound interpretation, as described in the disclosure AI models were developed to identify key anatomical structures at eFAST scan sites, simplifying image acquisition by assisting with proper probe placement. These models plus image interpretation diagnostic models are paired with two real-time eFAST implementations. The first implementation is a manual AI-driven ultrasound eFAST tool that uses guidance models to select correct frames prior to making any diagnostic predictions. The second implementation is a robotic imaging platform capable of providing semi-autonomous image acquisition combined with diagnostic image interpretation. Both real-time approaches were used in a swine injury model, for example, and performances highlighted in an emergency medicine application. As described herein, AI can be deployed in real time to provide rapid triage decisions, lowering the skill threshold for ultrasound imaging at or near the point of injury.

As such, embodiments described herein relate to the use of an artificial intelligence model to automate an eFAST examination.

The development of artificial intelligence (AI) has accelerated in several fields of technology, including the healthcare industry. In the medical imaging field, AI has improved efforts in patient care and medical diagnoses of disease and abnormalities. AI not only reduces the time it takes to diagnose these problems, but also gives supplemental insight to medical providers by finding and interpreting abnormalities that could have otherwise been missed by a human eye unfamiliar with discerning nuanced features. In addition, technological advancements have allowed for improved care administration for trauma patients on the battlefield. One example is the use of internet-based video communication to receive real-time advice from medical professionals to properly treat or address casualty patients. Closed-loop systems for fluid or drug administration utilize fully automated medical administration approaches to stabilize patients that are being transported to more definitive care. Robotics improve the treatment administration of surgical interventions through telerobotic platforms.

The implementation of artificial intelligence (AI) models is therefore a significant force multiplier benefit in scaling diagnostic capabilities in military medicine. Having an AI model(s) interpret images for injury diagnosis could effectively alleviate the responsibilities from specially trained medical providers to combat medics, thus allowing more personnel to aid with emergency triage. Due to the variability in emergencies on the battlefield, it is difficult to predict surges in trauma emergencies that are consequentially considered as mass casualty incidents, therefore having a model to provide diagnostic predictions would help with response time in triaging.

Having diagnostic models to interpret medical images, however, only addresses part of the challenge with performing eFAST exams. The other issue is adequate medical image acquisition for discernable image capture so that AI models can interpret the presence of injury. For this, AI and robotics are applied to the eFAST exam, utilizing computer vision AI to guide a robotic platform to the relevant scan points of the eFAST exam. Having a trained model to classify diagnostics for ultrasound images can also objectify the process of making decision during triage and lower the skill threshold needed to obtain diagnosis predictions once ultrasound images are acquired.

The utilization of artificial intelligence (AI), especially in research and medicine, has accelerated exponentially in recent times, propelled by big data and edge computing techniques, paired with the continuous development of improved computer hardware capabilities. Given the context of AI's revolutionary effect in the mainstream, there are currently a variety of AI models that have been developed for diagnostics, medical examination procedures, and treatment personalization. For medical imaging, AI is used to assist in determining, or identifying the status of patients across the most common medical imaging techniques, such as computed tomography, magnetic resonance imaging, and ultrasound imaging. This helps automate the process that would otherwise take more time to complete manually and with a lower margin of subjectivity or bias. As triaging procedures are relatively standardized, it is beneficial to free medical professionals from these tasks, to allow them to delegate more time for urgent patients or protocols. This results in having a quicker, more effective triaging response in specific, unprecedented circumstances such as mass casualty situations.

AI models were developed and evaluated for intrabdominal or intrathoracic free fluid detection in ultrasound images across some of the standardized eFAST scan locations to automate diagnosis on the battlefield. The models implemented are deep learning-based image classification models trained using ultrasound images captured in swine subjects. The models developed, tested, and described herein include lighter models with fewer parameters, Bayesian optimized architectures for this specific application, and larger, multi-output conventional models. Moreover, the trained deep learning models described herein are integrated with automated eFAST image acquisition and interpretation in real-time, allowing for model inferencing in live and euthanized swine. An acquisition method includes a handheld AI-driven US application that guides the user to the correct scan site using AI guidance models and then runs AI diagnostic models, for example. In addition, a robotic imaging platform equipped with computer vision AI to detect scan sites, as well as AI guidance and diagnostics to confirm proper image capture and make scan site diagnostic predictions is further envisioned.

The real-time AI-driven ultrasound imaging triage tools described herein have the potential to lower the skill threshold of image-based triage decisions. The handheld application has a small footprint optimal for ease of deployment in which the end user can position the ultrasound probe correctly and make proper image interpretation decisions. The robotic-driven image capture application further automates the procedure but with a larger size, which may not be suitable in the earliest phase of trauma medical care. In conclusion, both applications provide evidence of the promise AI can provide to simplify medical imaging and improve medical triage decisions on the future battlefield and in pre-hospital settings.

Of interest in the development of the embodiments disclosed herein is the recognition that artificial intelligence (AI) can be trained for image interpretation of hemorrhages leading to a reduction in stress on resources used to save lives in a mass causality situation including on the medical providers. Deep learning AI models that can be trained to interpret free fluid in eFAST scan sites can reduce diagnostic processing time and help improve triage in emergency pre-hospital situations. To that end, to improve ultrasound interpretation, AI models were developed to identify key anatomical structures at eFAST scan sites simplifying image acquisition by assisting with proper probe placement. These models plus image interpretation diagnostic models may be paired with various real-time eFAST implementations. An implementation described herein is a manual AI-driven ultrasound eFAST tool that used guidance models to select correct frames prior to making any diagnostic predictions. An additional implementation is the use of these AI models with a robotic imaging platform capable of providing semi-autonomous image acquisition combined with diagnostic image interpretation. Both real-time approaches were used in a swine injury model, for example, and performances highlighted in an emergency medicine application. As described herein, AI can be deployed in real time to provide rapid triage decisions, lowering the skill threshold for ultrasound imaging at or near the point of injury.

The eFAST triage methodology is a modification of the original FAST examination which only assessed intrabdominal hemorrhage and pericardial effusion. Four standardized scan points were identified in the FAST methodology for (i) Subxiphoid view to identify pericardial (PC) effusion, (ii) Right Upper Quadrant (RUQ) view for detection abdominal hemorrhage in the hepatorenal recess, (iii) Left Upper Quadrant (LUQ) view for fluid identification in the splenorenal recess, and (iv) pelvic or bladder (BLD) view for assessing the rectovesical or rectouterine pouch. The extension of this methodology incorporated in the eFAST procedure integrated thoracic ultrasound imaging for identifying pneumothorax (PTX) or hemothorax (HTX) injuries as indicated by free air or blood in the pleural space, respectively, diagnosed by ultrasound imaging multiple intercostal space views on the left and right chest.

Ultrasound imaging is an important tool in emergency medicine for initial assessment of injuries and triaging patient status for prioritizing medical evacuation resources. The utility for ultrasound imaging can be extended if the skill threshold can be lowered for acquisition and interpretation of scan results so that imaging-based triage can be more common in the pre-hospital military or civilian setting. The eFAST triage application described herein is very useful for detecting free fluid in the thoracic or abdominal cavities and positive eFAST diagnosis can often require urgent surgical intervention. AI image interpretation models for identifying positive and negatives status at each scan point can streamline this process without needing ultrasonography expertise if high accuracy AI models can be trained for this application. To this end, different approaches and model architectures were highlighted for each eFAST scan point to optimize their performance.

In at least one embodiment, the source of the ultrasound images to be analyzed is immaterial and may be from manual scans or robotic/automated scans of the patient. The AI model as explained herein was trained on a variety of ultrasound images reflecting a variety of injuries and healthy examples. The model performs its analysis on a processor connected to a memory and the source of the ultrasound images. The model is configured to perform the analysis associated with an eFAST examination by reviewing the ultrasound images for the presence of fluid (e.g., air pocket or loose fluid internal to the patient). In at least one embodiment, different AI models are used for different scans used as part of the eFAST analysis. The model is trained on a variety of ultrasound images reflecting the conditions to be found if present by an eFAST examination. The following discussion explains the development of the model and ways that one or more of those models have been improved. As part of the embodiments of this disclosure, the model can review ultrasound images from both uninjured and injured patients and determine if the patient does in fact have the internal injuries detectable by eFAST to assist in the triage in a mass casualty situation.

### Model Development

Research was conducted in compliance with the Animal Welfare Act, the implementing Animal Welfare regulations, and the principles of the Guide for the Care and Use for Laboratory Animals. Live animals subjects were maintained under a surgical plane of anesthesia and analgesia. Ultrasound scans were captured at the eFAST scan points from two approved swine protocols prior to instrumentation, as 10 second brightness (B-) mode clips for all scan sites or motion (M-) mode images over a 5 second window for the thoracic scan regions. The first protocol (n=13 subjects) involved a splenectomy surgery followed by a burn injury to then study response to burn resuscitation for a 24-hour period, after which the subject was euthanized. The second protocol (n=14 subjects) started with a splenectomy, followed by two rounds of controlled hemorrhage and fluid resuscitation. After the second resuscitation ultrasound scans were captured for only the thoracic region and right upper quadrant (RUQ) scan site since the subject was in prone position, after collecting ultrasound clips the subject was euthanized.

After euthanasia from either protocol, ultrasound scans were obtained at every eFAST scan point except for the pericardial site and left upper quadrant (LUQ). For the thoracic region, pneumothorax (PTX) and hemothorax (HTX) injuries were created by inserting air or blood through a triple lumen central veinous catheter (Arrow International, Morrisville, NC, USA) placed near the axillary region, connected to tubing and a peristaltic pump. The catheter was introduced using a modified version of the Seldinger technique, by inserting the needle in between the pleural layers. Ultrasound scans were then collected specifically in the PTX or HTX injury regions as B-mode or M-mode clips. The abdominal hemorrhage (AH) injuries were created by reopening part of the abdominal incision and inserting the tubing from the peristaltic pump near the apex of the liver. As fluid pooled near the kidney/liver interface, or around the bladder, ultrasound scans were collected in RUQ and BLD regions as positive for injury.

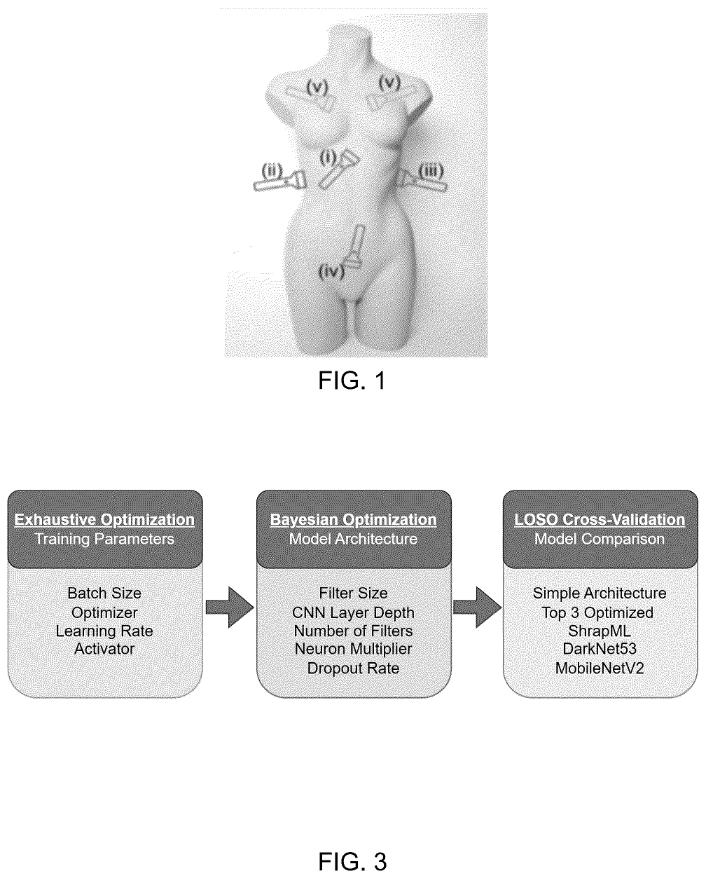

FIG. 1 provides an overview of eFAST scan sites or locations. Views include (i) subxiphoid, (ii) right upper quadrant, (iii) left upper quadrant, (iv) pelvic, and (v) intercostal scan points, in accordance with various embodiments of the present disclosure. As previously discussed,

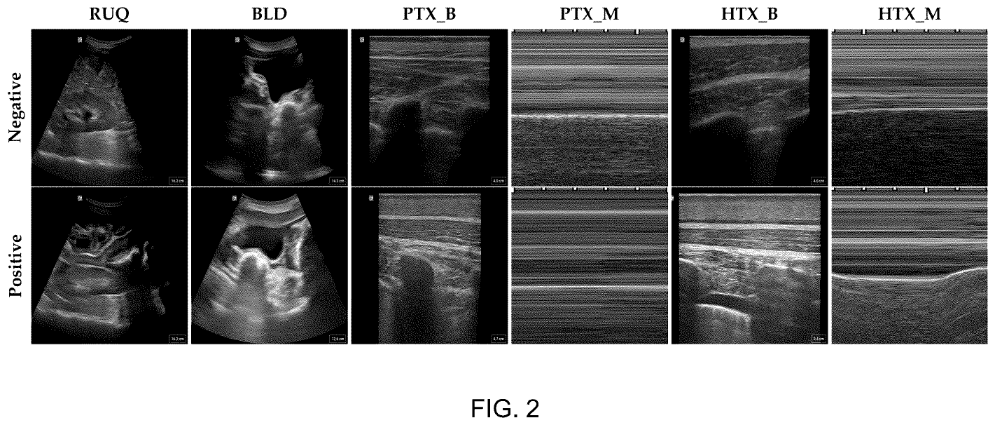

A total of 6 scan sites were evaluated across several AI architectures. The PTX and HTX sites were evaluated for both B-mode (PTX_B, HTX_B) and M-mode (PTX_M, HTX_M) image capture. Reference is made to FIG. 2 that illustrates representative ultrasound images for each scan point. Each column shows ultrasound images at the different scan points for negative (top) or positive (bottom) injury state, in accordance with various embodiments of the present disclosure. Images for the LUQ or cardiac site were not used due to all swine subjects undergoing a splenectomy procedure, and post-mortem injury model did not allow for properly replicating this site.

Ultrasound images were collected from live and euthanized swine for pneumothorax (PTX, B,M-Mode), hemothorax (HTX, B,M-Mode), and abdominal hemorrhage at the thoracic, right upper quadrant (RUQ, B-Mode) or pelvic (BLD, B-Mode) regions (FIG. 2). All live procedures were performed with animals under a surgical plane of anesthesia with analgesia. Images were sorted by each animal subject and by diagnoses for each injury condition (positive or negative, Table 1). Ultrasound scans were collected using either a linear or curvilinear transducer with the Sono-site PX System (Fujifilm, Bothwell, WA), and then organized by protocol, subject, scan region, and injury classification as either positive or negative. All-Further pre-processing was performed using MATLAB (MathWorks, Natick, MA, USA), where the B-mode clips were split into frames, cropped to remove the user interface information, and then resized to 512×512 pixels. For the M-mode images, the motion capture segment was split into 25 single second cropped sections using a rolling window. These sections were then resized to 512×512 pixels for consistency. Total number of images across the training dataset is summarized in Table 1.

TABLE 1
Summary of total number of images for each diagnostic classification
and the number of swine subjects for each scan point.

| Scan Point | RUQ | BLD | PTX_B | PTX_M | HTX_B | HTX_M |
|---|---|---|---|---|---|---|
| Positive Images | 30000 | 20845 | 34957 | 4525 | 76431 | 9368 |
| Negative Images | 31396 | 22049 | 54420 | 6425 | 54420 | 6425 |
| Total Number | 61,396 | 42,894 | 89,377 | 10,950 | 130,851 | 15,793 |
| of Images | | | | | | |
| Subjects | 25 | 21 | 22 | 20 | 25 | 25 |

Before setting up any training for the AI models, images were initially split into image datastores for each scan point using MATLAB. The datastores were implemented to automate categorizing image datasets based on different characteristics of the images such as the scan site, diagnosis, and subject.

FIG. 3 illustrates a flowchart of architecture optimization pipeline. Sequence of optimization rounds with the parameters that were varied, in accordance with various embodiments of the present disclosure. Three different model training approaches were taken as shown in FIG. 3: exhaustive optimization, Bayesian optimization, and cross-validation evaluation. Datasets were spliced into different size clusters for each training approach so that subjects did not have any redundancy between data splits that would otherwise cause data leakage. Total image quantity varied between subject and scan site, to standardize amount of training data, subsets of images with injury were split by scan site. Negative images were subsequently loaded into the data splits to match the number of positive images in each.

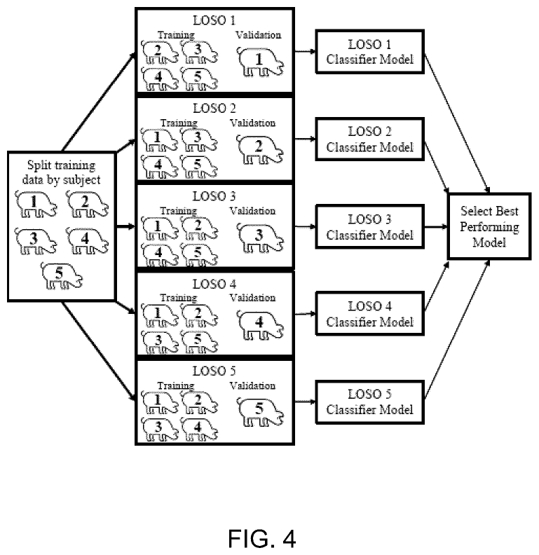

The approach used to split the images started with performing a grid search method for parameter combinations in a simple convolutional neural network. Then, Bayesian optimization on model architecture parameters, optimizing for best test accuracy. The process used a leave one subject out (LOSO) cross-validation method with optimized models, convolutional neural networks (CNNs) such as DarkNet53, MobileNetv2 and a model for shrapnel detection. The LOSO method was implanted in training where images were organized into 5 clusters of data sets representing each subject as illustrated in FIG. 4. FIG. 4 illustrates an overview of the LOSO method as applied to swine ultrasound images, in accordance with various embodiments of the present disclosure.

The starting convolutional neural network (CNN) model architecture for the optimization approach for each scan site was adapted from a published TensorFlow example. Briefly, the model used three 2D CNN layers with 16, 32, and 64 total filters with a filter size of 3 for each of three layers. Each layer used a rectified linear unit (ReLU) activator followed by a max pooling layer. The output of the model after the third CNN layer was a fully connected layer with an output size of 2 which utilized a variable activation layer. Parameters chosen for optimization round 1 (FIG. 3) focused on training hyperparameters rather than the architecture, apart from the final activation layer. The parameters chosen and the values tested are as follows: (i) batch size—16, 64, 128—the number of images fed into the model with each training iteration; (ii) optimizer—RMSProp, ADAM, SGDM—algorithms used to minimize the error of the model loss function; (iii) learning rate—0.001, 0.0005, 0.0001—the rate at which the model updates its weights, or “learns”; and (iv) final activator—softmax or softplus—a function that evaluates the feature maps from the final convolution layer before they are fed to the classification layer.

As shown in FIG. 3, the first round of AI training included of an exhaustive optimization of training parameters, with different combinations of training options. These approaches used 2 data splits, one as training and validation dataset, and the second as blind test images. From each of the B-Mode scan point image sets, 2500 images were selected at random from the training split as well as another 500 images for validation. 500 images were then taken at random from the blind test images to be used for testing models after training. Due to the reduced number of images for M-Mode scan points, 1250 images were pulled for training, and 250 images for both the validation and testing datasets.

Before training, random image augmentation was implemented in three ways to add variability to the ultrasound images. First, Y-axis reflection randomly flipped images about the Y-axis. Next, random rotation was implemented allowing up to 36 degrees of rotation in either direction. The final image augmentation was random scaling, scaling the image within a range from 0.90 to 1.10. For training, a MATLAB script was developed to cycle through each unique combination of optimization parameters and train a model before moving on to the next. A total of 54 unique training runs were conducted in this stage to a maximum of 100 epochs. The models were trained with an early stopping function, called “validation patience” using MATLAB. The function's purpose is to reduce time spent on improving model performance if it is not continuously improving after a user defined period of epochs. This value was set to 5 epochs, meaning that if the validation loss values did not improve after 5 epochs, the model terminated training early.

To select the best performing model from the first phase of optimization, accuracy scores were taken from predictions on the blind test dataset for all 54 trained models. For each model with an accuracy of 0.5 or higher, 0.5 was subtracted from the score. If the accuracy was below 0.5, a score of 0 was assessed for that model. This approach was taken so that all optimized parameters received a score across each of the 54 trained models. These scores were then summed, resulting in an overall score for each unique parameter. For example, a model with parameters of 16 batch size, rmsprop optimizer, a learning rate of 0.001, a softmax activator, and a 0.74 accuracy would add 0.24 to the overall score for each of these parameters. Once these scores were compiled, the highest score for each parameter was then selected as optimal for moving on to the second phase of optimization.

After the initial exhaustive optimization, a second optimization phase was set up to further improve model performance (FIG. 3) using Bayesian optimization, focused on the model architecture rather than training parameters. Optimization parameters and their ranges of values for round 2 are as follows: (i) filter size—integers ranging from 2 to 7—the size of the convolution kernel; (ii) number of layers—integers ranging from 2 to 6—the number of convolution layers in the model; (iii) number of filters—integers ranging from 2 to 16—the number of output feature maps for the first convolution layer; (iv) multi-plier—real numbers from 1 to 2—the factor by which the number of filters increases with each layer; and (v) dropout, rate at which feature maps were randomly removed from the model flow, to help prevent overfitting. The dropout layer was added to the end of the model for this phase of optimization, before the final activation and classification layers (integers from 1 to 9, then divided by 10 for creating rates between 10% and 90%).

Training was conducted with the same data setup for exhaustive optimization now using MATLAB's bayesopt function. This function takes a set of parameters and range of values for each parameter and attempts to find the best combination of parameters to maximize a given output function. In this case, the function being maximized is the accuracy value given after testing each trained model on the set of blind test images. Like previously, validation patience was set to 5 epochs for a maximum of 100 epochs. Training options were set based on the best performing options from round 1 of optimization. The bayesopt function attempted random combinations of the architecture parameters up to a maximum of 100 unique combinations. With each model trained, the function adjusted the parameters within the set constraints to yield a better accuracy score. The three models with the highest accuracy scores were then chosen as the best performing and evaluated through full LOSO training runs.

When evaluating a model's architecture and its potential to be used in a practical setting, testing its performance on blind datasets is a qualitative method of determining how well a model can generalize new data based on the data on which it was trained. Deploying the LOSO method in the model's training provides a way to test an architecture's ability to generalize by giving a variety of different training datasets as well as test datasets with blind data. For a given scan point, the swine subjects were split into similarly sized clusters where each cluster is referred to as a subject in the LOSO training set up. By creating five LOSO clusters the algorithms were able to effectively experience different training and testing datasets. This was used to evaluate how different architectures are able to generalize to datasets

For testing model performance, 5 different CNN-based architectures for each scan site (FIG. 3) were compared: (i) the original CNN architecture prior to any optimization, termed “Simple CNN”; (ii) the top 3 Bayesian optimized model architectures, termed “Optimized CNN” and one model results are shown based on which had the highest average accuracy; (iii) the ShrapML CNN architecture which was previously optimized for ultrasound image interpretation; (iv) the MobileNetV2 model which had the highest performance in previous ultrasound imaging applications; and (v) DarkNet53 model architecture as an example of a CNN architecture with more depth that has also performed successfully for ultrasound image interpretation.

Similar to the training setup for model optimization, an image database categorized by scan point, image mode type, and swine subject number were used to divide the data up evenly into five clusters by subject number for each scan point (RUQ, BLD, HTX_B, HTX_M, PTX_B, and PTX_M). The five clusters represented “subjects” in a LOSO training setup wherein data for 4 subjects were merged for training and validation while the remaining subject was held out across five LOSO splits. 16,000 total images (8,000 positive and negative image labels) were randomly selected from the training data for B-mode. With less images for M-mode data types, only 4,000 total images (2,000 for each class) were used. The images were augmented with up to 10% random rotation, random y-axis reflection, and 10% random image re-scaling. An additional 2,000 or 500 images were randomly selected for split validation data for B-mode and M-mode, respectively. For blind test data, 2,000 or 500 images were randomly selected for each LOSO setup for B-mode and M-mode, respectively. Training was performed with up to 100 epochs, using a similar validation patience of 5 and training parameters as dictated by optimization results.

Model performance was measured by comparing predictions on blind holdout data for each LOSO split versus ground-truth labels. Through this comparison test image results were split into True Positive (TP), True Negative (TN), False Positive (FP), and False Negative (FN) labels and were used to construct confusion matrices. Using these labels, performance metrics for accuracy, precision, recall, specificity, and F1-scores were calculated using established definitions. In addition, the area under the receiver operator characteristic (AUROC) curve was quantified for the positive label category for test images in each LOSO split. Performance metrics were calculated using MATLAB. GraphPad Prism 10.1.2 (La Jolla, CA, USA) was used for statistical analysis of performance metrics for optimization and LOSO training as well as data visualization.

To better illustrate model explainability, gradient-weighted class activation mapping (GradCAM) was used to generate heat map overlays for TP, TN, FP, and FN image labels using MATLAB. 5 images of each label were randomly generated for each model architecture, training LOSO, and scan site. The generated GradCAM overlays provide “hot spots” that indicate what areas of the image were more important to the predicted label to determine if the AI model is accurately tracking injury location to better understand performance.

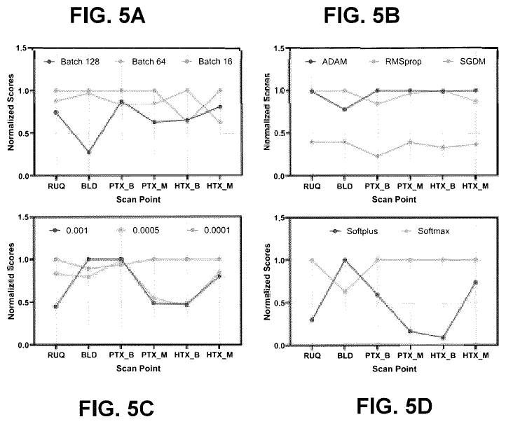

FIGS. 5A-5D illustrates normalized performance score for the exhaustive optimization for each scan site. Graphical representation of results for: (A) batch size, (B) optimizer, (C) learning rate, and (D) activation function. Results are normalized to the maximum performing model for each scan site, resulting in the data being gated between 0 and 1 (n=54 exhaustive optimization model runs), in accordance with various embodiments of the present disclosure.

The CNN model was first optimized across 4 main hyperparameters: (i) batch size, (ii) optimizer, (iii) learning rate, and (iv) final layer activator, in an exhaustive optimization (see methods). Starting with batch size, the smaller 16 image batch size was optimal for all but the HTX_B models which favored a 64-image batch size (FIG. 5A). Optimizer and learning rate were more split across the scan sites but only two of the possible options were selected, with SGDM and 0.005 not being preferred by any scan site (FIG. 5B, FIG. 5C). For all scan points but BLD, softmax was selected as the final layer activator, as BLD optimized to the softplus layer (FIG. 5D). However, the BLD scan site had poor training performance across all optimization runs with 0.61 blind test accuracy being the strongest results. The overall selected features for each scan site are summarized in Table 2.

TABLE 2
Summary of selected parameters for each eFAST scan point
based on exhaustive optimization of CNN model.

| | Batch Size | Optimizer | Learning Rate | Activator |
|---|---|---|---|---|
| RUQ | 16 | rmsprop | 0.0001 | softmax |
| BLD | 16 | rmsprop | 0.001 | softplus |
| PTX_B | 16 | adam | 0.001 | softmax |
| PTX_M | 16 | adam | 0.0001 | softmax |
| HTX_B | 64 | rmsprop | 0.0001 | softmax |
| HTX_M | 16 | adam | 0.0001 | softmax |

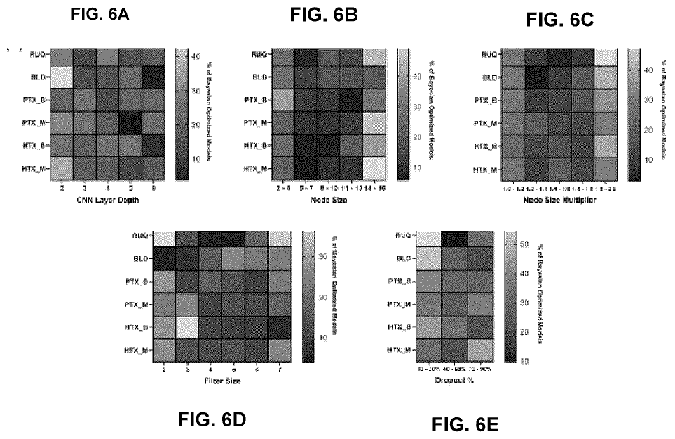

The CNN model architecture was optimized across a wider range of hyperparameter using a Bayesian optimization approach. Five different hyperparameters were tuned through this methodology—(i) filter size, (ii) number of layers, (iii) number of filters, (iv) multiplier, and (v) dropout rate after the fully connected layer. Distributions of the 100 Bayesian optimization runs are shown in FIGS. 6A-6E for each hyperparameter, to highlight what features per scan site the optimization method focused on. For most scan sites, the top performing optimized architectures had similar setups, with each of the PTX_B models having 3 CNN layers or each HTX_M model having the same filter size, dropout rate, and node size. For others, the model parameters varied significantly, such as BLD with a wide range selected across all optimized parameters. However, the blind test accuracy was low for optimization once again for BLD, with the top performing model achieving 0.57 accuracy. As a result of heterogeneity in some of the selected parameters for scan sites, the top three model setups were further evaluated using LOSO cross-validation training. A summary of the top three performing model architectures is shown in Table S1.

TABLE S1
Summary of top 3 three performing architecture hyperparameter
configurations based on Bayesian optimization.

| | | CNN | Node | | Filter | | |
|---|---|---|---|---|---|---|---|
| | | Depth | Size | Multiplier | Size | Dropout | Accuracy |
| RUQ | 1^{st} | 4 | 13 | 1.99356 | 7 | 3 | 0.867 |
| | 2^{nd} | 5 | 16 | 1.96767 | 7 | 8 | 0.859 |
| | 3^{rd} | 5 | 16 | 1.93826 | 7 | 8 | 0.857 |
| BLD | 1^{st} | 2 | 2 | 1.61756 | 6 | 2 | 0.575 |
| | 2^{nd} | 4 | 10 | 1.91307 | 7 | 5 | 0.57 |
| | 3^{rd} | 5 | 11 | 1.86532 | 2 | 8 | 0.569 |
| PTX_B | 1^{st} | 3 | 16 | 1.82879 | 5 | 1 | 0.747 |
| | 2^{nd} | 3 | 13 | 1.02141 | 2 | 5 | 0.744 |
| | 3^{rd} | 3 | 16 | 1.17496 | 4 | 1 | 0.74 |
| PTX_M | 1^{st} | 2 | 16 | 1.00818 | 3 | 3 | 0.86 |
| | 2^{nd} | 2 | 2 | 1.47797 | 3 | 9 | 0.853 |
| | 3^{rd} | 2 | 12 | 1.02064 | 3 | 3 | 0.845 |
| HTX_B | 1^{st} | 4 | 16 | 1.008018 | 3 | 6 | 0.854 |
| | 2^{nd} | 4 | 13 | 1.941593 | 5 | 6 | 0.842 |
| | 3^{rd} | 5 | 16 | 1.677502 | 2 | 3 | 0.836 |
| HTX_M | 1^{st} | 3 | 16 | 1.832214 | 2 | 9 | 0.874 |
| | 2^{nd} | 4 | 16 | 1.884837 | 2 | 9 | 0.866 |
| | 3^{rd} | 3 | 16 | 1.192284 | 2 | 9 | 0.844 |

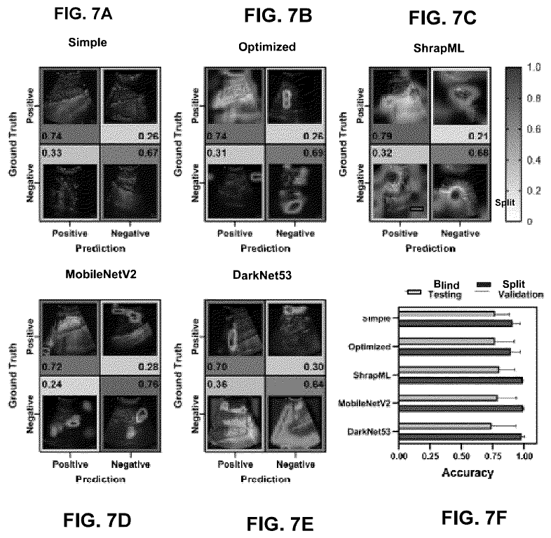

FIGS. 7A-7F illustrate prediction results from the LOSO training regimen for the RUQ scan site for different AI architectures, in accordance with various embodiments of the present disclosure. For FIGS. 7A-7E: Confusion matrices with GradCAM representative AI prediction results for TP, TN, FP and FN results for (FIG. 7A) Simple CNN architecture, (FIG. 7B) top optimized CNN model, (FIG. 7C) ShrapML, (FIG. 7D) MobileNetV2, and (FIG. 7E) DarkNet53. Confusion matrix values are shown as relative amounts to each ground truth category, resulting in TP and FP rates shown in the first column and FN and TN rates shown in the second column for blind test image predictions. The GradCAM overlay highlights relevant regions for the AI prediction in red/yellow tones. (FIG. 7F) Summary of accuracy metric scores for blind test and split validation data sets for each model. Results are shown as mean values across LOSO cross-validation runs (N=5 splits). Error bars denote standard deviation, in accordance with various embodiments of the present disclosure.

For each scan site, 7 different model architectures were compared using 5 LOSO training cuts, resulting in five different blind test results which were averaged for each scan site and model. Starting with the RUQ scan site, ShrapML had the highest TP rate or recall (0.79, FIG. 7C) while MobileNetV2 had the highest TN rate or specificity at 0.77 (FIG. 7D). For assessing feature identification in ultrasound images, GradCAM overlays are used to produce images for each confusion matrix category. The Simple CNN model was focusing on small features that often traced the boundary of the kidney in TP or TN predictions (FIG. 7A) while ShrapML was often tracking features in the image larger than where hemorrhage would be identified (FIG. 7C). The optimized, MobileNetV2, and DarkNet53 models were focused on smaller regions in the image that were often near where AH would be identified (FIGS. 7A-7F).

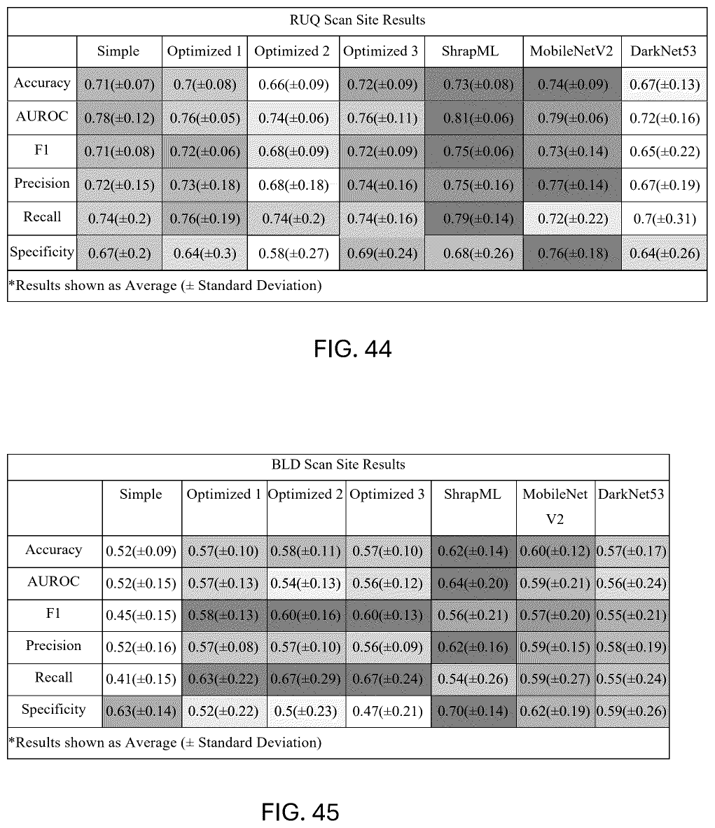

Based on overall accuracy, MobileNetV2 had the strongest blind test performance at 0.79±0.15 but all models except for DarkNet53 were above 0.70 (FIG. 7F). Different to validation accuracies where the lowest accuracy was for the Optimized model at 0.90±0.08 and MobileNetV2, DarkNet53, and ShrapML all having scores of 0.98 or higher (FIG. 7F). Summary of blind test performance metrics for each RUQ model, including the three Optimized models, are summarized in the table shown in FIG. 44.

FIG. 44. Blind test performance metric summary for each model architecture for the RUQ scan site. Results are shown for each metric as mean values across the 5 LOSO runs with standard deviation shown in parentheses. Heat map overlay is setup for gray shading in the table to indicate the stronger performing model for each row, metric.

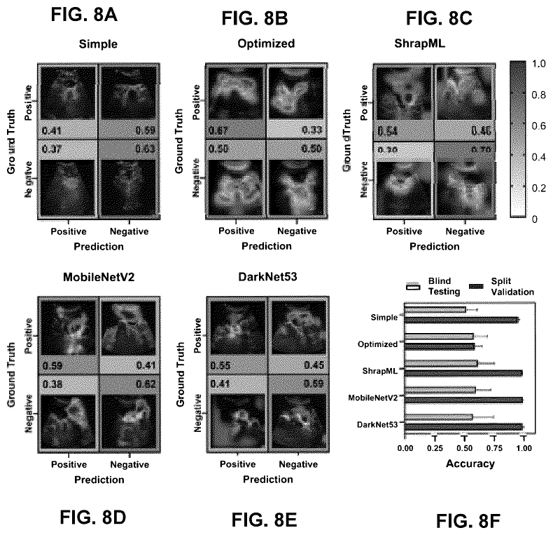

FIGS. 8A-8F illustrate prediction results from the LOSO training regimen for the BLD scan site for different AI architectures. For FIGS. 8A-8E: Confusion matrices with GradCAM representative AI prediction results for TP, TN, FP and FN results for (FIG. 8A) Simple CNN architecture, (FIG. 8B) top optimized CNN model, (FIG. 8C) ShrapML, (FIG. 8D) MobileNetV2, and (FIG. 8E) DarkNet53. Confusion matrix values are shown as relative amounts to each ground truth category, resulting in TP and FP rates shown in the first column and FN and TN rates shown in the second column for blind test image predictions. The GradCAM overlay highlights relevant regions for the AI prediction in red/yellow tones. For FIG. 8F: Summary of accuracy metric scores for blind test and split validation data sets for each model. Results are shown as mean values across LOSO cross-validation runs (N=5 splits). Error bars denote standard deviation, in accordance with various embodiments of the present disclosure.

For the BLD scan site, performance remained low for all architectures, but results differed between higher recall for the Optimized CNN (0.67, FIG. 8B) while the rest of the architectures had higher specificity, with ShrapML having rate at 0.70 (FIG. 8C). Looking at the heat map prediction overlays, the simple CNN model continued to segment out the edges of the region of interest when making accurate predictions (FIG. 8A). All other models were tracking the proper BLD region of interest or peripheral region around the bladder for image predictions.

However, overall blind test accuracy was low for all models with ShrapML having the highest accuracy at 0.62±0.14 while Simple CNN had the lowest accuracy at 0.52±0.09 accuracy (FIG. 8F). Based on validation accuracy, results showed a strong overfitting trend with accuracies above 0.95 for all models except the Optimized model with 0.59±0.06 accuracy (FIG. 8F). Summary of blind test performance metrics for each BLD model, including the three Optimized model setups are summarized in the table shown in FIG. 45.

FIG. 45. Blind test performance metric summary for each model architecture for the BLD scan site. Results are shown for each metric as mean values across the 5 LOSO runs with standard deviation shown in parentheses. Heat map overlay is setup for gray shading in the table to indicate the stronger performing model for each row, metric.

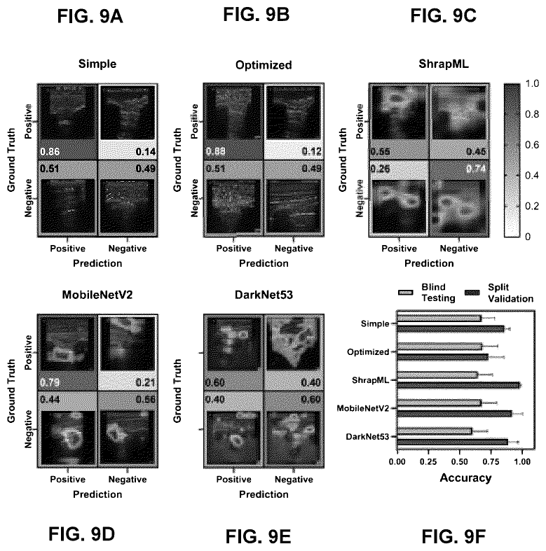

FIGS. 9A-9F illustrate prediction results from the LOSO training regimen for the PTX_B scan site for different AI architectures. For FIGS. 9A-9E: Confusion matrices with GradCAM representative AI prediction results for TP, TN, FP and FN results for (FIG. 9A) Simple CNN architecture, (FIG. 9B) top optimized CNN model, (FIG. 9C) ShrapML, (FIG. 9D) MobileNetV2, and (FIG. 9E) DarkNet53. Confusion matrix values are shown as relative amounts to each ground truth category, resulting in TP and FP rates shown in the first column and FN and TN rates shown in the second column for blind test image predictions. The GradCAM overlay highlights relevant regions for the AI prediction in red/yellow tones. FIG. 9F: Summary of accuracy scores for blind test and split validation data sets for each model. Results are shown as mean values across LOSO cross-validation training runs (N=5 splits). Error bars denote standard deviation, in accordance with various embodiments of the present disclosure.

For PTX injury models, B-mode and M-Mode image modalities were separately evaluated to determine if one approach was more readily automated. PTX_B models showed strong recall, evident for the simple CNN, optimized CNN, and MobileNetV2 models, with each reaching above 0.79 for this metric (FIG. 9). Conversely, only ShrapML was able to surpass 0.70 specificity scores, with most other models being close to 0.50. On average, the highest blind test accuracy was 0.68 with a number of model architectures nearing this score threshold (FIG. 9F). DarkNet53, MobileNetV2, and ShrapML had higher overfitting tendencies with split validation accuracies at 0.89, 0.92, and 0.98, respectively.

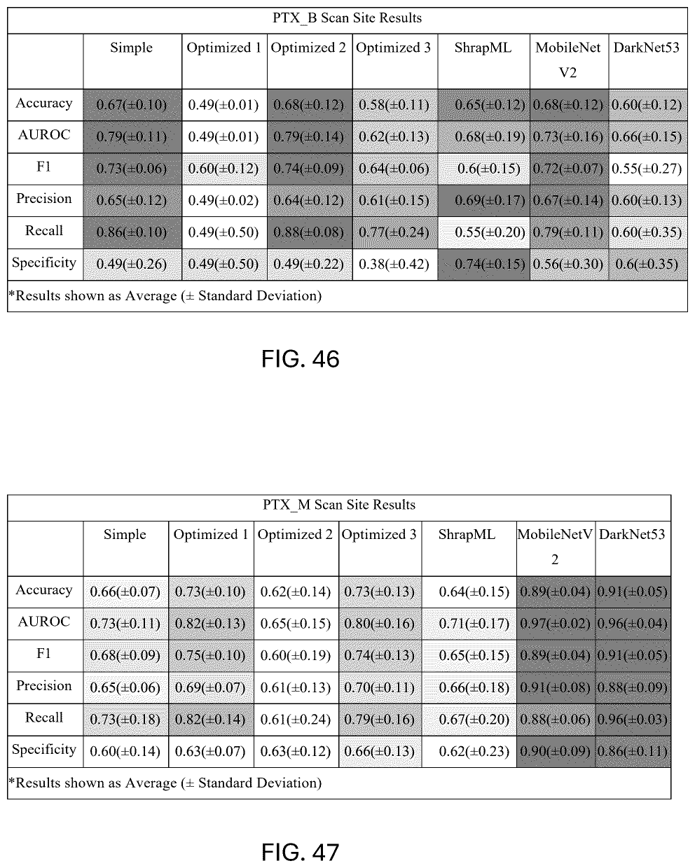

GradCAM overlays were similar for the simple and optimized CNN models with both tracking small features throughout the ultrasound images while ShrapML, MobileNetV2, and DarkNet53 were tracking larger regions (FIG. 9). MobileNetV2 most often identified the pleural space, where injury is evident for PTX, but DarkNet53 and ShrapML frequently identified additional regions in the images (FIG. 9). Summary of blind test performance metrics for all trained PTX_B models are summarized in the table shown in FIG. 46.

FIG. 46. Blind test performance metric summary for each model architecture for the PTX_B scan site. Results are shown for each metric as mean values across the 5 LOSO runs with standard deviation shown in parentheses. Heat map overlay is setup for gray shading in the table to indicate the stronger performing model for each row, metric.

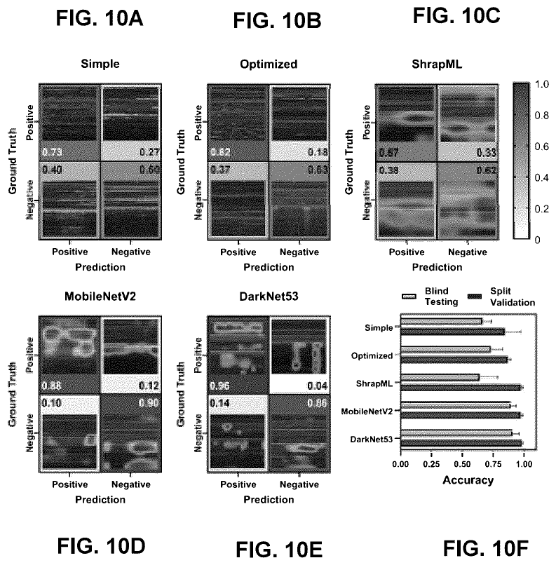

FIGS. 10A-10F illustrate prediction results from the LOSO training regimen for the PTX_M scan site for different AI architectures; see FIGS. 10A-10F. Confusion matrices with GradCAM representative AI prediction results for TP, TN, FP and FN results for (FIG. 10A) Simple CNN architecture, (FIG. 10B) top optimized CNN model, (FIG. 10C) ShrapML, (FIG. 10D) MobileNetV2, and (FIG. 10E) DarkNet53. Confusion matrix values are shown as relative amounts to each ground truth category, resulting in TP and FP rates shown in the first column and FN and TN rates shown in the second column for blind test image predictions. The GradCAM overlay highlights relevant regions for the AI prediction in red/yellow tones. (FIG. 10F) Summary of accuracy metric scores for blind test and split validation data sets for each model. Results are shown as mean values across LOSO cross-validation training runs (N=5 splits). Error bars denote standard deviation, in accordance with various embodiments of the present disclosure.

For PTX_M, all models performed well at identifying positive injuries in test image sets, with DarkNet53 reaching 0.96 recall (FIG. 10E). MobileNetV2 had the strongest specificity at 0.90 followed closely by DarkNet53 at 0.86 while all other models had lower performance (FIG. 10). Evaluating heat map overlays showed a similar trend for the Simple and Optimized CNN models where small features are evident in each GradCAM im-age. The other models identified the pleural line, or the regions below it in the image, where PTX injuries are most easily identified due to lack of lung motion (FIG. 10).

Overall, blind test accuracies for MobileNetV2 and DarkNet53 were very strong at 0.89±0.04 and 0.91±0.05, respectively. These models far outperformed the others, with the next highest accuracy at 0.73±0.10 for the Optimized model. For split validation accuracies, ShrapML had the highest discrepancy from blind test scores (split validation=0.97±0.02 vs. blind test=0.64±0.15) likely indicating high overfitting to training data. Summary of performance metrics for each trained PTX_M model is summarized in the table of FIG. 47.

FIG. 47. Blind test performance metric summary for each model architecture for the PTX_M scan site. Results are shown for each metric as mean values across the 5 LOSO runs with standard deviation shown in parentheses. Heat map overlay is setup for gray shading in the table to indicate the stronger performing model for each row, metric.

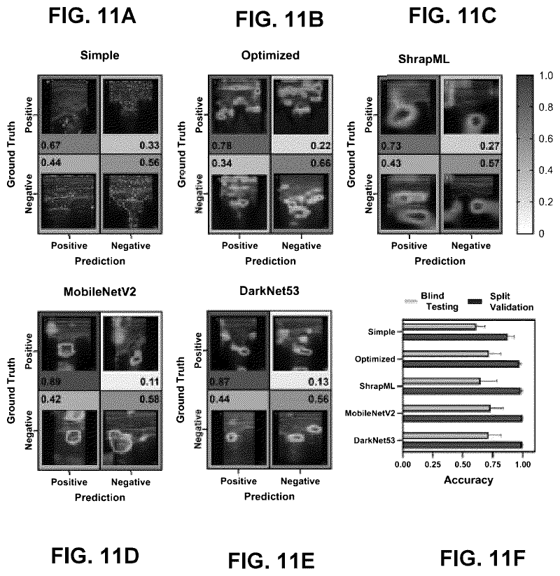

FIGS. 11A-11F illustrate prediction results, in accordance with various embodiments of the present disclosure, from the LOSO training regimen for the HTX_B scan site for different AI architectures. (FIGS. 11A-11E: Confusion matrices with GradCAM representative AI prediction results for TP, TN, FP and FN results for (FIG. 11A) Simple CNN architecture, (FIG. 11B) top optimized CNN model, (FIG. 11C) ShrapML, (FIG. 11D) MobileNetV2, and (FIG. 11E) DarkNet53. Confusion matrix values are shown as relative amounts to each ground truth category, resulting in TP and FP rates shown in the first column and FN and TN rates shown in the second column for blind test image predictions. The GradCAM overlay highlights relevant regions for the AI prediction in red/yellow tones. (FIG. 11F: Summary of accuracy metric scores for blind test and split validation data sets for each model. Results are shown as mean values across LOSO cross-validation training runs (N=5 splits). Error bars denote standard deviation, in accordance with various embodiments of the present disclosure.

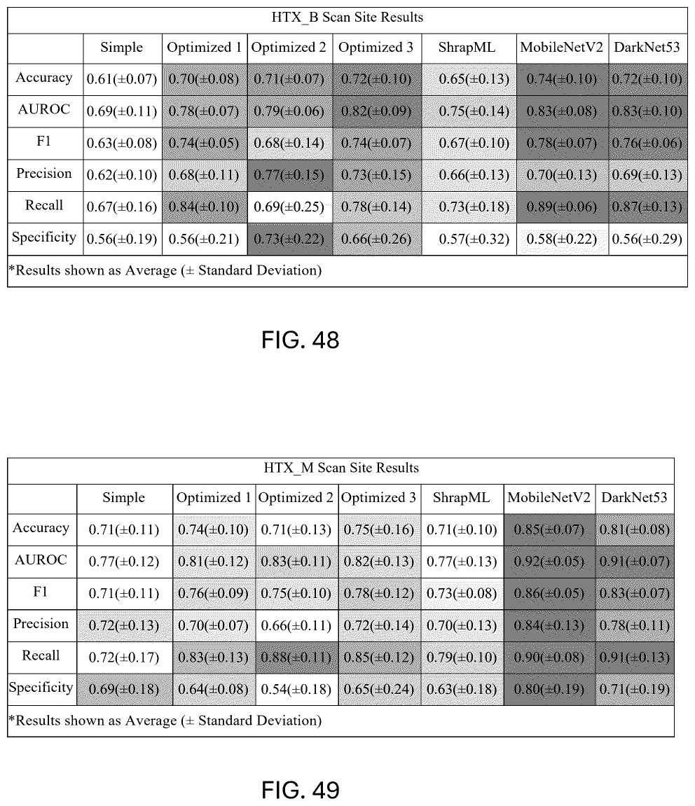

For HTX B-mode models, performances were skewed toward higher recall and lower specificity. MobileNetV2 and DarkNet53 models had the highest recall scores at 0.89 and 0.87, respectively (FIG. 11D, 11E), while the Optimized model achieved only 0.66 specificity. GradCAM overlays for all models but Simple CNN were accurately making decisions based on the pleural space between the rib spacing, in accordance with a standard clinical di-agnostic approach (FIG. 11A-E). For overall blind test accuracy, HTX B-mode models performed better than PTX B-mode models, with three model architectures surpassing 0.70 accuracy while no PTX_B models exceeded this performance (FIG. 9F). The highest performing model was MobileNetV2 at 0.74±0.10. However, there was still a large overfitting trend when looking at split validation accuracy metrics with all models except the Simple CNN (0.88±0.05) model surpassing 0.97 split accuracy scores (FIG. 11F). Summary of blind test performance metrics for each HTX_B model, including the three Optimized model setups are summarized in Table S6 the table of FIG. 48.

FIG. 48. Blind test performance metric summary for each model architecture for the HTX_B scan site. Results are shown for each metric as mean values across the 5 LOSO runs with standard deviation shown in parentheses. Heat map overlay is setup for gray shading in the table to indicate the stronger performing model for each row, metric.

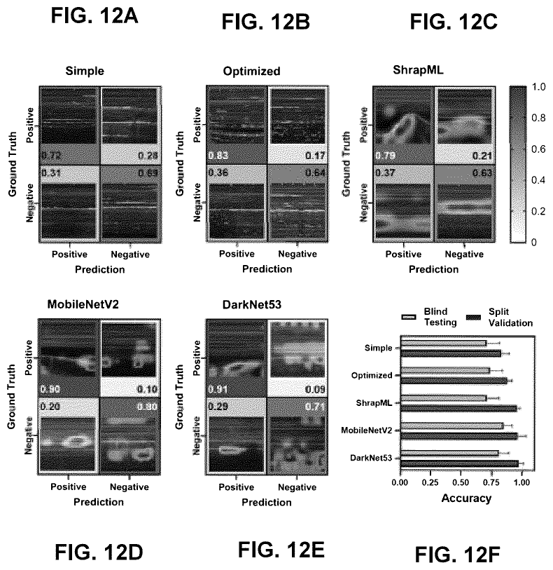

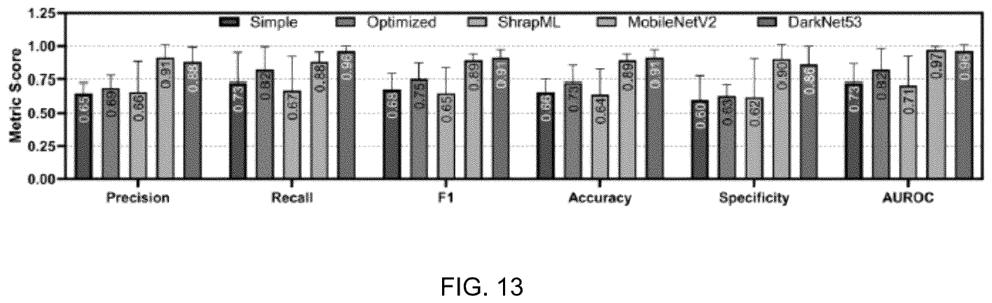

FIGS. 12A-12F illustrates prediction results from the LOSO training regimen for the HTX_M scan site for different AI architectures. FIGS. 12A-E: Confusion matrices with GradCAM representative AI prediction results for TP, TN, FP and FN results for (FIG. 12A) Simple CNN architecture, (FIG. 12B) top optimized CNN model, (FIG. 12C) ShrapML, (FIG. 12D) MobileNetV2, and (FIG. 12E) DarkNet53. Confusion matrix values are shown as relative amounts to each ground truth category, resulting in TP and FP rates shown in the first column and FN and TN rates shown in the second column for blind test image predictions. The GradCAM overlay highlights relevant regions for the AI prediction in red/yellow tones. FIG. 12F: Summary of accuracy metric scores for blind test and split validation data sets for each model. Results are shown as mean values across LOSO cross-validation training runs (N=5 splits). Error bars denote standard deviation, in accordance with various embodiments of the present disclosure.

For HTX_M, all models continued to trend towards higher recall, with DarkNet53 and MobileNetV2 both surpassing 0.90. Specificity trended lower with the lowest score of 0.63 for ShrapML and the highest value reaching 0.80 for MobileNetV2 (FIG. 12A-E). Based on GradCAM analysis, simple and optimized CNN models were tracking lines across the M-mode image vs. larger regions of interest. However, for TP results these lines often coincided with fluid in the pleural space (FIG. 12A, 12B). The other three model architectures were tracking the proper image regions including tracking the expansion of the pleural space due to the presence of fluid (FIG. 12C-E).

While HTX_B models outperformed PTX_B, HTX_M models performed worse in comparison to PTX_M, with highest blind test accuracies by MobileNetV2 and DarkNet53 only reaching 0.85±0.07 and 0.81±0.08 respectively (FIG. 12F). All other models had blind test accuracies between 0.70 and 0.74. Split validation accuracy trended higher again, with all models surpassing scores of 0.83 (FIG. 12F). Summary of blind test performance metrics for all trained HTX_M models are summarized in the table of FIG. 49.

FIG. 49. Blind test performance metric summary for each model architecture for the HTX_M scan site. Results are shown for each metric as mean values across the 5 LOSO runs with standard deviation shown in parentheses. Heat map overlay is setup for gray shading in the table to indicate the stronger performing model for each row, metric.

Overall, AI models trained on a number of the eFAST scan points resulted in high blind test performance while other scan points proved more challenging to create a generalized automated solution. Five different model architectures were evaluated using a LOSO cross-validation methodology, and each had mixed performance across the eFAST scan points and imaging modes. The simple network architecture represented a basic CNN model which may be sufficient for minimal interpretation of image information. The optimized models had their hyperparameters tuned for each scan point application. ShrapML was previously optimized for an ultrasound imaging application and outperformed conventional architectures for shrapnel identification in tissue. MobileNetV2 was selected as it had best performed for shrapnel detection compared to other models. DarkNet53 was an example of a much deeper neural network with many more trainable parameters to evaluate and determine if this design was more suitable for this application.

For the M-Mode imaging modality used in the PTX_M and HTX_M scan sites, MobileNetV2 and DarkNet53 outperformed the other architectures. An interesting finding as this modality generally allows for straightforward diagnosis compared to B-mode, which would be expected to require simpler model architectures. This result had less to do with the other models performing worse and pertained to MobileNetV2 and DarkNet53 training much better for these scan points, compared to the B-mode equivalent. This is logical in the context that M-Mode images are reconstructed from 100's of B-mode vertical slices allowing the AI model to have contextual awareness, while B-mode interpretations must rely on a single image frame. This is especially challenging for thoracic scan sites as lung motion can result in the PTX or HTX injury being hidden in a single B-mode frame which is less likely to be missed in an M-mode image. This temporal image complexity may not be suitable for more simple CNN architectures as suggested by the larger, more complex model architectures outperforming in this work. Furthermore, it could suggest value in having a time series ultrasound image input for improving image training as M-mode results outperformed all B-mode results. Other studies have utilized higher order inputs to CNN models to include more contextual detail or successfully integrate recurrent neural network architecture for better tracking time series details in ultrasound images.

For the other scan sites, RUQ had similar performance across most of the trained models, with accuracy in the low 0.70 range. However, split validation accuracy was 0.90 or higher for all architectures, indicating the models were overfitting the training data and unable to interpret different subject variability in the test data. Of note, the performance across the LOSOs was highly variable for this scan site, with the range of accuracies for the five LOSO runs ranging from 0.87 to as low as 0.60 for MobileNetV2. The training and test noise were potentially inconsistent across data splits suggesting that strategies to better account for subject variability will be needed. Improved data augmentation can be one strategy to improve these results as it has been successful in improving model performance for various medical applications.

The BLD scan point resulted in the worst training performance, with the best average model result reaching only 0.62 accuracy. There were a number of data capture and physiological challenges with this scan site that may partially explain this poor performance. First, images captured in live animals occurred after a urinary catheter was placed which sometimes resulted in small, uniform bladder sizes. While more images were captured post-mortem for this scan site in which the bladder was replenished to a wider range of bladder sizes, the live animal images were only negative for hemorrhage while post-mortem were both positive and negative for abdominal hemorrhage. As a result, the negative BLD live animal images may be creating a very challenging training problem. Another challenge with this scan point is that unlike other scan points, there are two changing variables—bladder size and AH severity—compared to the other scan points having a single variable—free fluid quantity. This additional variable makes training models for this scan point challenging and may require additional data augmentation strategies or more robust model architectures to improve performance.

Two of the most important aspects of a model's training dataset are its size and its variability. Improvements to all model performances are made by addressing dataset's issues with both size and variability of a model's training dataset in mind. The dataset size issue is addressed by collecting more images as well as training models on more images. However, larger datasets represent a higher computational training burden making larger, more complex model architectures cumbersome to evaluate. Instead, focus can be set on artificially increasing dataset variability to combat model overfitting. Image augmentation and transformation is the simplest way to do this, without needing to collect more ultrasound images. For ultrasound image classification tasks, oftentimes training data is collected from ultrasound video clips where very little variability is evident on a frame-by-frame basis. The image transformation performed in this paper was chosen with the idea of producing a level of variability that one may expect from ultrasound images. Rotations and scaling were kept relatively restricted as intuition would leave one to believe that scaling an ultrasound image to one tenth of its original size would not happen in a practical setting. However, it is possible to see better performance when using data augmentation that would produce a non-useful image when viewed by a human observer. data augmentation improvement may include increasing the types of transforms used while also using optimization techniques to tune the parameters of these different transforms.

The AI models developed support automating image interpretation for an eFAST scan point for detecting free fluid in the thorax and abdominal cavity. Improved training strategies to reduce model overfitting and create more generalized diagnostic models are included. In addition, these models combined into a real-time format for pairing with handheld ultrasound technology so that predictions are provided easily to the end-user, to enable pairing with techniques that are in development to improve image acquisition such as virtual reality or robotic solutions. Combining the AI models developed with image acquisition solutions drastically lowers the skill threshold for ultrasound based medical triage enabling its use more readily in ambulatory and combat casualty care.

Consequently, AI models were successfully trained for each eFAST scan point with all CNNs. Focusing on the PTX scan site, model performance accuracy varied from 0.66 for the basic CNN model to 0.91 for DarkNet-53. For the BLD scan site, performance across all models was lower than the rest of the scan points, indicating some need for additional pre-processing augmentations or model fine-tuning. Table 3 illustrates the performance metrics for models trained at the BLD scan site. FIG. 13 illustrates the performance metrics of all models for PTX-M scan site, in accordance with various embodiments of the present disclosure.

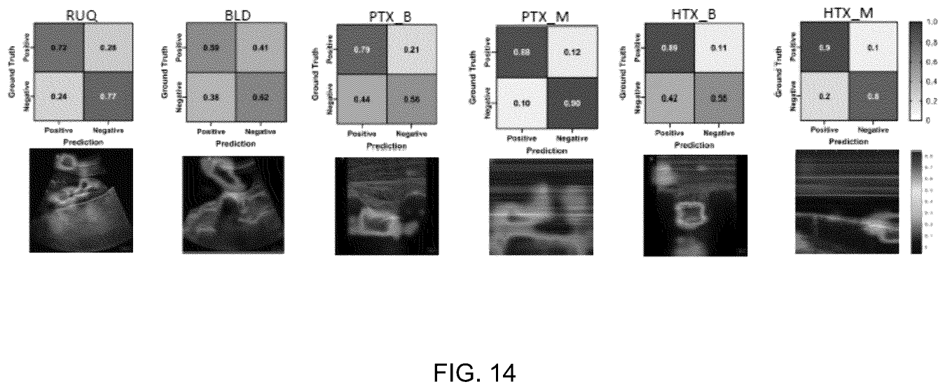

FIG. 14 illustrates a diagram of confusion matrices and Gradient-weighted class activation mapping (GradCAM) overlays of MobileNetv2 inferencing. Confusion matrices utilize ground truth image labels and blind tested images. GradCAM overlays are on “True Positive” image labels using MATLAB, in accordance with various embodiments of the present disclosure.

While FIG. 14 illustrates a diagram of confusion matrices and Gradient-weighted class activation mapping (GradCAM) overlays of MobileNetv2 inferencing with confusion matrices utilize ground truth image labels and blind tested images. GradCAM overlays are on “True Positive” image labels using MATLAB.

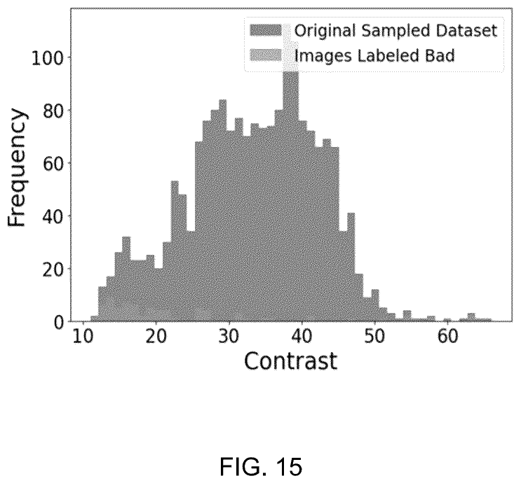

Next, bad frames were removed from the ultrasound images. This was implemented with a preprocessing step using statistical analysis on ultrasound images for BLD and RUQ scan sites to automate the removal of bad ultrasound (US) images. The parameters analyzed were average pixel brightness, contrast, and signal to noise ratio. FIG. 15 illustrates a histogram comparing the contrast scores of ultrasound images labeled poor and original sample dataset. Image statistics for images user-labeled as poor in signal quality were calculated to quantitatively set a floor that US images need to reach to be considered for training.

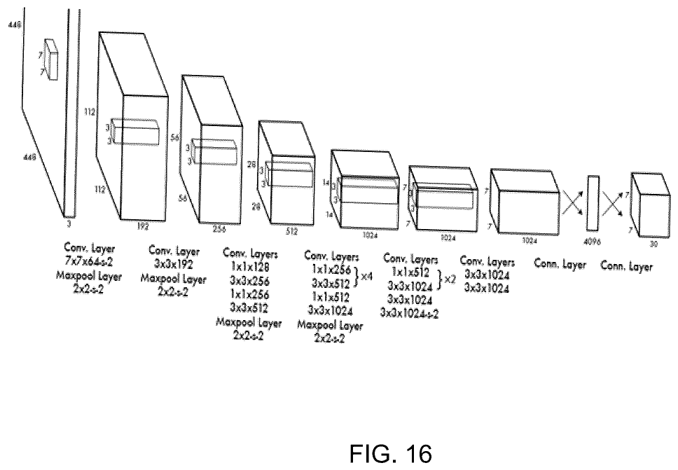

As illustrated in FIG. 16, a YOLO classification model was implemented in training to compare against the other models that needed to be fine-tuned.

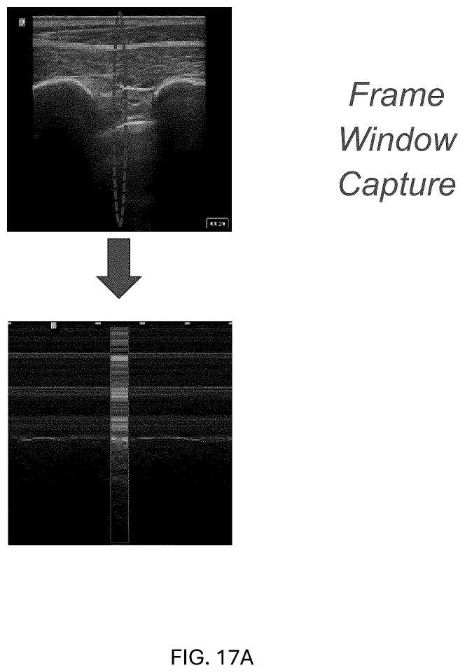

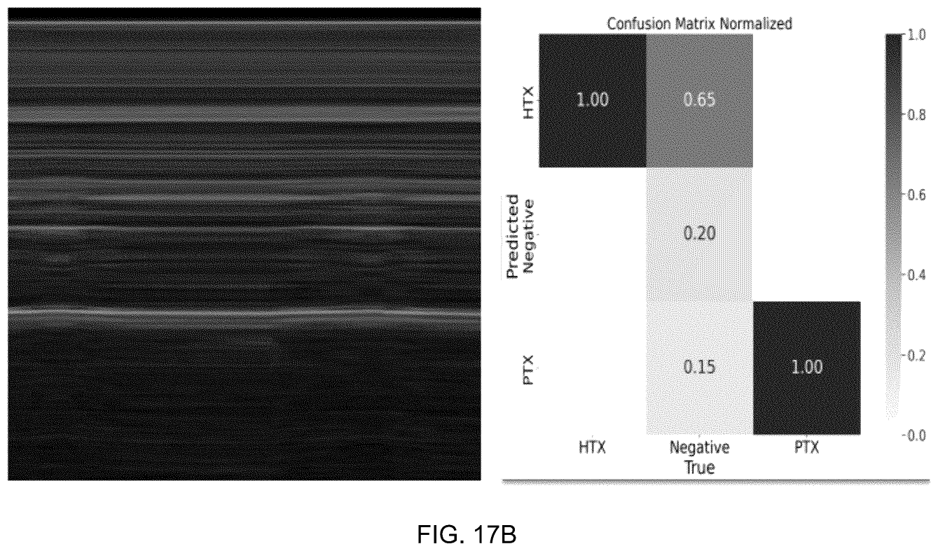

To improve image capturing and tune the performance of M-Mode models, a preprocessing step was added that splices vertical lines from the center of ultrasound scans to automate the creation of “custom” M-mode ultrasound images from B-Mode ultrasound captures. An example of this is illustrated in FIGS. 17A and 17B. FIGS. 17A-B illustrate a demonstration of custom M-Mode slices created from B-Mode images, in accordance with various embodiments of the present disclosure. The sampling rate, number of frames, and stride can be manipulated to make ultrasound images have more temporal context. While all the scan points except for BLD and RUQ had similar variations in accuracies to each other, testing new methods has shown some improvements in these scan points. Removing bad US frames and retraining models showed a slightly higher 78% in blind testing for BLD and 80% for RUQ. YOLO diagnostic models set up in a LOSO split procedure performed with a higher 80% to low 90% accuracy in BLD scan point; this is further tested on new blind subjects to verify performance.

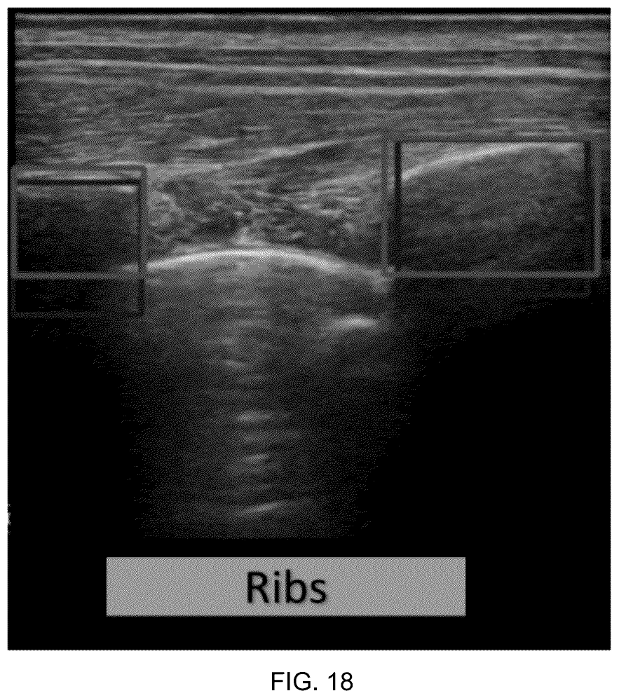

FIG. 18 illustrates an ultrasound scan showing a rib, in accordance with various embodiments of the present disclosure. Additional improvements were gained from using YOLOv7 object detection model to identify ribs in thoracic B-Mode ultrasound images like that illustrated in FIG. 18. FIG. 18 includes annotations to ground truth rib placement prior to training.

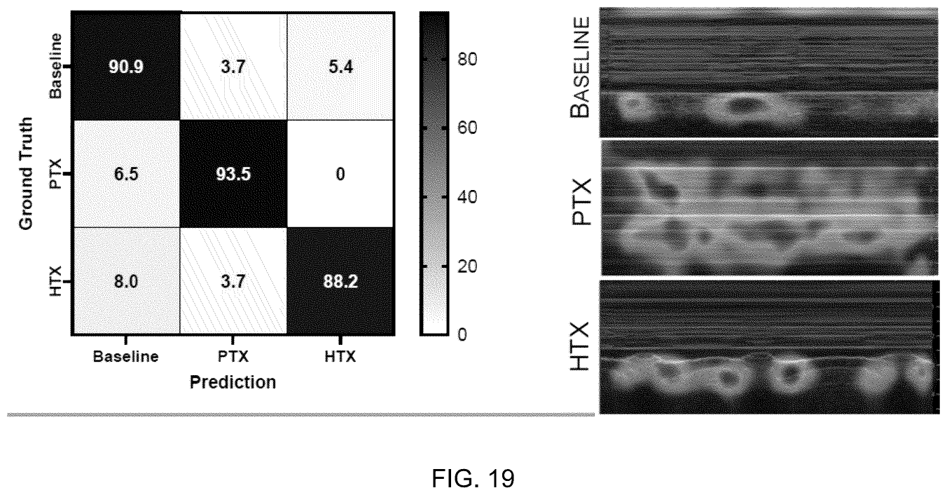

FIG. 19 illustrates three classes, 5 second window size for a thoracic scan, in accordance with various embodiments of the present disclosure. FIG. 19 illustrates three classes, 5 second window size for a thoracic scan.

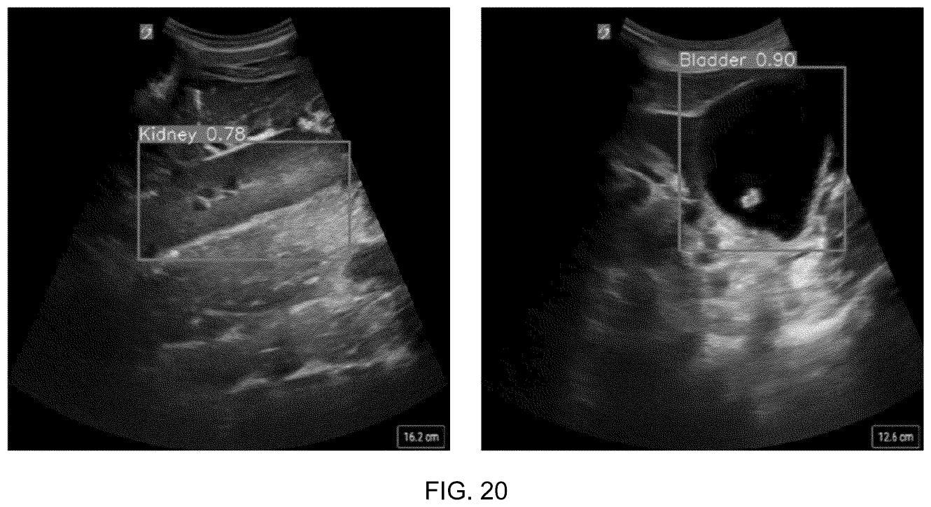

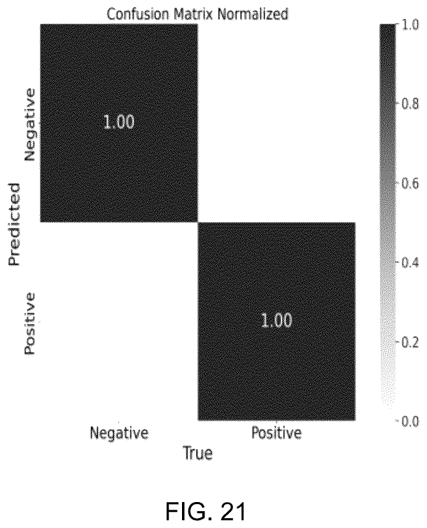

FIG. 20 illustrates a pair of abdominal ultrasound scans with RUQ/BLD guidance AI, in accordance with various embodiments of the present disclosure. FIG. 20 illustrates a pair of abdominal ultrasound scans with RUQ/BLD guidance AI. There was high variability in abdominal ultrasound image capture for RUQ, so each video was checked for injury status and severity. Retraining of the model occurred without “slight” injury status or videos where anatomical features less in view. The retraining used a YOLOv8 classification framework as it was successful for object detection model development. FIG. 21 illustrates a confusion matrix normalized, in accordance with various embodiments of the present disclosure.

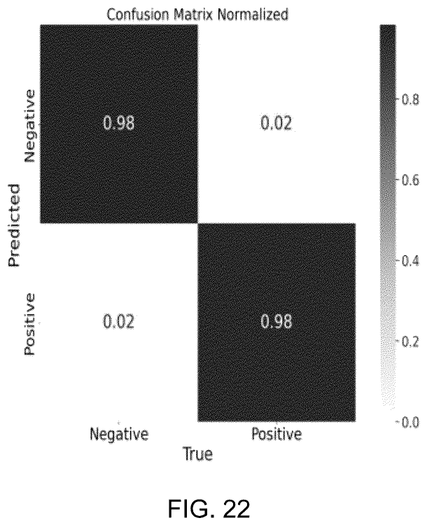

The work led to improved BLD diagnostic AI for abdominal scans. There was high variability in abdominal ultrasound image capture, so each video was checked for injury status and severity. Retraining of the model occurred without “slight” injury status or videos where anatomical features less in view. The retraining used a YOLOv8 classification framework as it was successful for object detection model development. FIG. 22 illustrates a confusion matrix normalized, in accordance with various embodiments of the present disclosure.

A summary of AI results for eFAST is as follows:

| Scan Point | Guidance Performance | Classification Performance |
|---|---|---|
| Thoracic | 0.729 IOU | Custom M-Mode = 73.0% |
| (PTX/HTX) | | Real M-Mode = 90.8% |
| RUQ | 0.858 IOU | 100.0% |
| BLD | 0.903 IOU | 98% |

### A Further Example

### Example Animal Procedures and Manual Ultrasound Image Capture

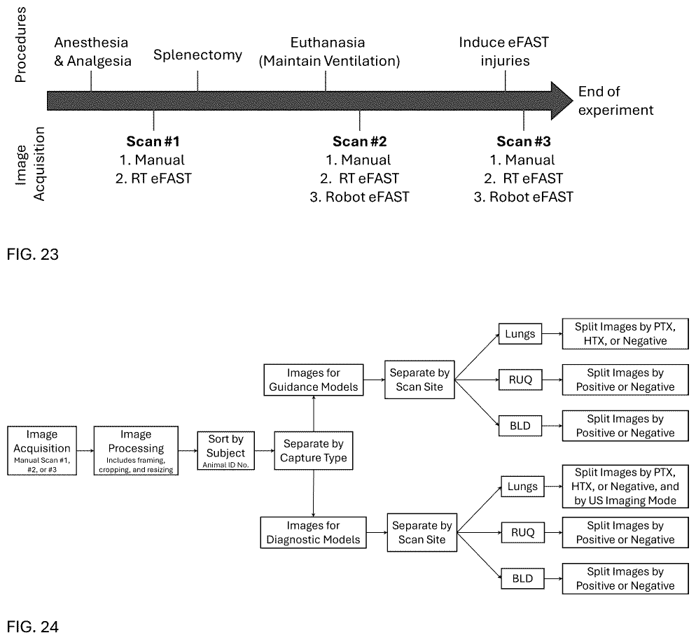

In accordance with another example test, US scans were captured at eFAST scan sites using a swine model from three approved animal research protocols. FIG. 23 provides an overview of the animal study procedures and image capture timelines in this example. Ultrasound images were captured prior to splenectomy in live swine, as well as at two time points in euthanized swine (before and after eFAST injury induction). Each scan landmark in the diagram lists how US images were captured. The three approaches were manual US image capture, image capture using a real-time (RT) eFAST handheld application, and image capture using the robotic imaging platform. For all studies, images were captured immediately after instrumentation procedures and before laparotomy to remove the spleen, Scan #1 in FIG. 23). Each animal study was focused on different shock-related injuries, and splenectomies were performed to minimize the variability due to splenic contraction and autotransfusion. Since the spleen was removed in all protocols, no US scans were captured in the left upper quadrant, or LUQ, scan site. After the subjects were euthanized, two imaging rounds took place: before (Scan #2 in FIG. 23) and after inducing abdominal hemorrhage (AH), pneumothorax (PTX), and hemothorax (HTX) injuries at the respective scan sites (Scan #3 in FIG. 23).

For manual image capture, images in the thoracic region were captured using a linear array probe, and at the abdominal scan sites a curvilinear array probe was used (C5, Sonosite, Fujifilm, Bothwell, WA, USA), using a Sonosite PX (Fujifilm, Bothwell, WA, USA) US System. Images were captured for two different AI training applications: guidance and diagnostic AI models. For the diagnostic training dataset, thoracic US scans were captured as 10 s B-mode (brightness mode) clips or as 5 M-mode (motion mode) images, captured at multiple intercostal spaces. For guidance, 10 s B-mode clips were captured as a single swipe along all intercostal spaces of the thorax bilaterally. The abdominal scans were obtained at two locations: the right upper quadrant (RUQ), focusing on the kidney-liver interface, and the pelvic region (BLD), focusing on the areas around the bladder. For guidance image capture, 10 s region scans were captured in two motions: along the sagittal plane and along the medial plane. For diagnostic image capture, additional 10 s scans were captured while rocking the probe with the region of interest in view. All of these images were captured at three experimental timepoints, indicated as Scan #1, Scan #2, Scan #3 in Image Acquisition in FIG. 23.

### Data Processing

Ultrasound data from 36 pigs were exported from the US machine and sorted by experimental phase, subject ID, and scan point for both major scan types: guidance (scans along anatomical planes) and diagnostic (scans focused on organs, fluid accumulation sites), as diagrammed in FIG. 24. FIG. 24 provides an overview of ultrasound image dataset structure and processing for images captured in swine for eFAST AI model training, in accordance with various embodiments of the disclosure.

All ultrasound videos were split into frames, and individual images were cropped and resized to 512×512 pixels using the Image Processing Toolbox extension from MATLAB version R2023b (MathWorks, Natick, MA, USA). Images were cropped to remove words and other artifacts on the US scans that the AI model may have focused on during training. The US scans were reshaped to a 512×512 pixel size to create a symmetrical image geometry at a high resolution to detect small injury features. Successful US AI models have also been developed for similar applications using this image input size. For guidance frames, datastore file types were created containing random samples of the data, with major anatomical features labeled with bounding boxes around them: ribs for thoracic scans, the kidney for RUQ, and the bladder for BLD. Once the labels were generated, images in which the feature was not obviously visible were removed from the dataset. The bounding box labels were exported from MATLAB as four coordinates: x, y of the top left corner, and x-length, y-length of the bounding box.

For diagnostic scans, images captured during the pre-splenectomy and pre-injury phases were preliminarily classified as negative for injury and the post-injury captures as positive for injury. Then, a file tree of all items was generated, which allowed the review of every entry. As part of data curation prior to training the AI models, all US scans were reviewed for the presence of injury and assessed for overall image quality score, injury severity (none, slight, positive), and the presence of motion artifacts (only applied to thoracic scans). Image quality evaluated whether the US scans could be used to diagnose an injury. In accordance with an example embodiment, a score of 1 corresponded to a poor image quality, with most frames captured at an incorrect location; a score of 5 corresponded to a high image quality captured at a proper eFAST scan point, where diagnostic status could be properly assessed. This was performed by two scorers who agreed on image quality scores for the initial frames to help standardize scoring and conferred to finalize data curation if disagreement occurred for any image. When selecting data for training the AI models, those with a signal quality score below 3 and thoracic scans with large motion artifacts were not included in the training datasets. Scans labeled as “slight” injury were maintained in the dataset as positive for injury.

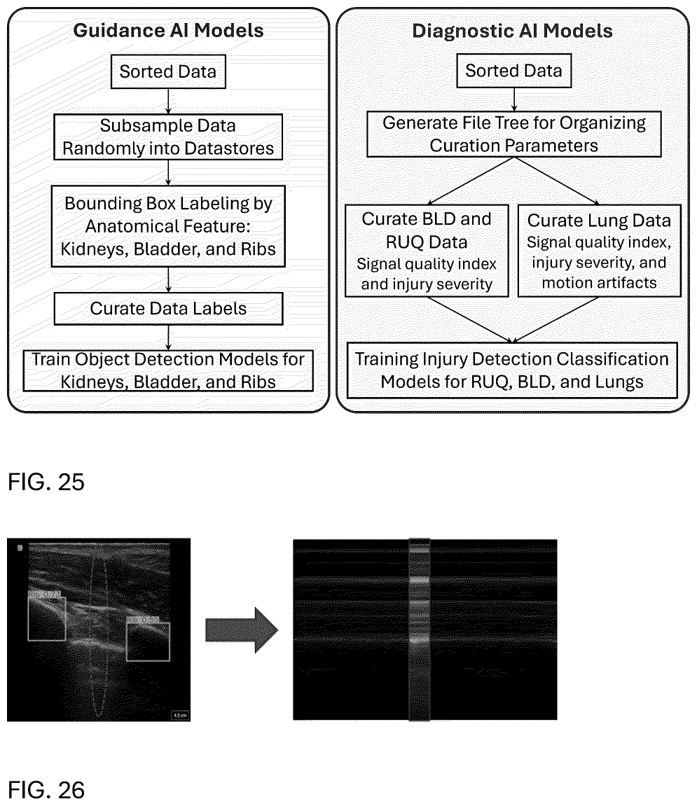

An overview of the AI model types used is shown in FIG. 25, in which a summary of data flow for eFAST AI model training is provided. For guidance models (diagram on the left in FIG. 25), data were subsampled, labeled, and then curated. More particularly, data was sorted; then subsample data was randomly stored into datastores; next, bounding box labeling by anatomical feature (such as kidneys, bladder, ribs) was performed (reference the red and blue bounding boxes shown for the ribs image capture in FIG. 18, the red bounding boxes of FIG. 20, for example); the data labels were assigned and curated; finally, object detection models were trained for the anatomical feature, such as kidneys, bladder, ribs. For diagnostic models (right diagram in FIG. 25), the sorted data were curated and then used for classification model training. More particularly, with regard to the diagnostic AI models, first data is sorted; a file tree is generated for organizing curation parameters; curate BLD and RUQ data (in this example) in which signal quality and injury severity is indexed and also curate lung data in which signal quality is indexed and injury severity and motion artifacts are logged; finally, injury detection classification models for RUQ, BLD, and Lungs are trained.

### Guidance AI Models

Once the data were labeled, the guidance AI models were trained using the YOLOv8 object detection architecture, with separate models tailored specifically for the detection of the kidneys (9449 labelled US images), bladder (7039 labelled US images), or ribs (44,736 labelled US images). The training process utilized the YOLOv8-S pre-trained model weights, default training parameters, and 100 epochs to provide ample opportunity for the models to learn and refine their predictions. To ensure robust model validation, a distinct dataset from subjects not used in training was reserved for the holdout testing of model performance. YOLOv8 was selected as the model architecture due to a variety of advantages when compared with other state-of-the-art object detection models. Primarily, this effort focused on the real-time application of object detection models with an eFAST-focused purpose. This meant that speed of prediction time was of high importance, even at the expense of slightly reduced accuracy. This narrowed the scope of possible models to be used to ‘single-stage’ architectures, where the single-stage model undertakes a single pass through of the image through the layers to determine the object location and class. Models like Faster R-CNN, for example, which can be more accurate, have a slower prediction time due to the image being processed into proposed regions of interest before being classified for objects. Moreover, when looking at single-stage models, YOLOv8 was amongst the fastest in frames per second, even beating out the single-shot detector (SSD) model and having only a slightly worse detection accuracy. Ease of use was also a driving factor for the use of YOLOv8 in this environment. The Python library ultralytics provides an API to allow for the seamless integration of YOLO models into existing software, for example.

For each guidance model trained, predictions were compared against the ground truth labels for the respective image, and Intersection-Over-Union (IOU) scores were calculated for each image. IOU is a metric for evaluating object detection models, calculated by dividing the area in which the predicted mask and ground truth mask overlap (intersection) by the total area covered by both masks (union). An IOU threshold of 0.5 is widely accepted in object detection applications as a standard for evaluating model performance, with scores at or above this threshold being acceptable. For kidney and bladder predictions, one object was expected for each frame, whereas for the thoracic image, two objects were expected. Regardless, for all predictions, the IOU score was calculated as an average across the entire image.

### Diagnostic AI Models

For diagnostic AI models, different approaches were used for the thoracic and abdominal regions. Each approach utilized the same YOLOv8 model architecture, except configured for classification for this use case. Diagnosis of injury in the abdominal region is regularly made from B-mode scans; as such, AI models were only trained using this type of imaging. In the thoracic region, due to the nature of lung sliding and how injuries present in ultrasound, M-mode images are a common means of distinguishing between injured and non-injured states. Diagnostic models trained for the thoracic region used two approaches: predictions from US-system-generated M-mode scans, or custom-generated M-mode images from a static hold in B-mode imaging mode. The latter approach is described below, followed by overall AI training procedures for the other scan points.

Diagnostic AI Models: Creating Custom Motion Mode Images from US Scans

For the development of diagnostic models focused on the thoracic region, first M-mode images were generated from the original B-mode US scans. This approach used a sequence of consecutive frames to create custom M-mode images. Each frame was processed through the guidance model for rib detection and, based on the predicted rib locations, the central point between the ribs was calculated. At this central point, a vertical slice was extracted from each frame as shown in FIG. 26. These slices were then concatenated to generate an image that closely resembled a genuine M-mode image. To ensure that a generated M-mode image was indicative of its diagnosis, the rib detection guidance model was used to filter out images without only two ribs visible. If a frame did not have exactly two ribs detected, that set of subsequent frames was not used for the M-mode creation process.

FIG. 26 provides an overview of how M-mode images were generated from B-mode frames using rib guidance AI models. Shown first in the left US image is a traditional B-mode ultrasound frame from which the guidance AI determined the location of the ribs (blue bounding boxes). A 3-pixel-wide region at the midpoint between the bound boxes (red dotted region) is selected across each frame to create a custom M-mode image, shown in the right US image.

An optimization process was conducted to determine the ideal set of parameters used to generate the images. These parameters included the number of frames per image, the width of the slice taken from each frame, the window stride between images, and the number of slices taken from each frame. The first two optimization parameters were concerned with the makeup of the generated M-mode images. For frames per image, 30, 90, and 150 frames per image were tested. In accordance with a specific example, images were captured from a video running at 30 frames per second, so these represent 1, 3, and 5 s capture windows. Three slice widths were also tested, these being 1-, 3-, and 5-pixel widths.

The remaining optimization parameters were focused on the generation of the training image dataset. The window stride parameter refers to the number of frames the model moves forward between images. For example, if using 30 images per generated M-mode and a stride of 15, one generated image will use frames 1-30, and the next will use images 15-45. The stride options used during the optimization were either 6 or 15 images, in a specific example. The final optimization parameter was the number of slices taken from each image, with either 1 or 3 slices being taken from each image. These parameters would affect both the number and makeup of images present in the training dataset.

These options produced 36 unique combinations of training parameters to be validated in the grid search using a YOLOv8 classification model trained for 100 epochs. After optimization, the resulting best parameters were as follows: 150-frame window size, 5-pixel slice width, 15-frame stride, and 1 slice taken per frame.

### Diagnostic AI Models: AI Models for Injury Identification

The diagnostic models were trained for injury detection at each eFAST scan site. For the abdomen, the AI models to identify AH injury were trained independently for the RUQ and BLD scan sites. For the thorax, two separate models were trained to predict if there was HTX, PTX, or no injury present, using either US-system-generated M-mode images or the custom generated ones as the input data. The dataset was split into 3 groups of 13 swine each to be able to perform the leave-one-subject-out (LOSO) cross-validation methodology. Each unique LOSO group was randomly generated from three research protocols and designated as a training, validation, or test set. Several AI model architectures were compared to develop AI models for each eFAST scan site. With the larger image dataset used in this study, these models needed to be retrained, and, for simplicity, utilized the same YOLOv8 architecture for image classification that was used for the AI guidance model development. The default training parameters were applied over a span of 100 epochs to allow for sufficient learning and refinement. Predictions were then tested on a holdout set of images from subject data not in the training data to test model performance. The best performing model from each scan site was then selected to be used in real-time testing.

### Real-Time Validation of AI Models

Real-time (RT) image capture was performed in three swine subjects completely separate from the dataset used to develop and test the underlying AI models. Each animal underwent imaging at the experimental timepoints shown in FIG. 23. Three real-time approaches were used: (i) RT eFAST application, which allowed for selection of a single scan site and capture of images while AI predictions for guidance and diagnostics occurred in RT; (ii) full handheld, manual eFAST examination, driven by AI guidance and diagnostic models; (iii) automated eFAST image capture using a robotic imaging platform equipped with computer vision, guidance, and diagnostic AI models. Each of these approaches is described in more details below.

Real-Time eFAST Application

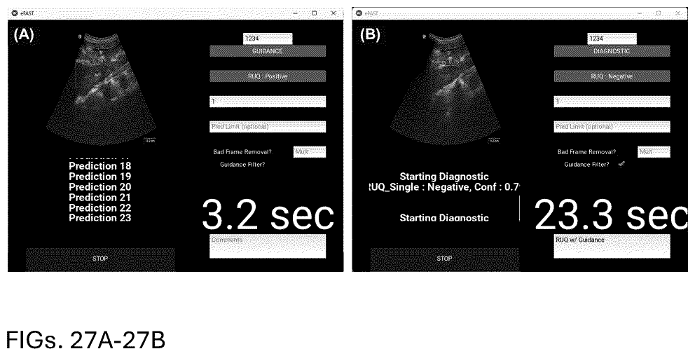

To enable the RT testing of models, a dedicated graphical user interface (GUI) was developed in Python using the Kivy library and designed to run on a laptop connected to the US machine via a Magewell USB Capture HDMI Gen 2 capture card (Magewell Electronics Co., Reading, PA, USA). The RT eFAST application allows users to input various experimental parameters, including subject identifier, scan mode (guidance or diagnostic), scan site (BLD, RUQ, M-mode, or RibsAI to generate M-Mode images), injury status, and number or duration of predictions as shown in FIGS. 27A, 27B, which provide an overview of the RT eFAST application. Additionally, the interface provides a comment section, with all inputs saved as a text file in addition to the prediction results from each individual scan. The best performing model in certain embodiments for each scan site and method that received the best blind test accuracy score was selected to be used in the real-time experiments. The trained model weights were packaged along with the GUI code to allow for the quick deployment of models and switching between models in real time. Users also have the option to select filtering methods that can be applied during the scan, as shown in FIG. 27B; these are further described in the next section.

Referring to example GUI shots shown in FIGS. 27A and 27B, in FIG. 27A, an GUI guidance AI model use is shown, while FIG. 27B illustrates a diagnostic AI model use, with guidance filtering active, is shown. These are representative screen shots shown for a RUQ scan site. The time refers to how long the application took to make predictions.

The RT eFAST application can be used for testing AI models in real time, as well as for data collection while performing the eFAST exam. The GUI allows the user to select relevant parameters for the operation and to start image capture. This in turn initializes the video stream and activates a thirty-second timer, which is displayed on the application. US imaging and RT predictions run for thirty seconds or until the specified number of predictions is reached, whichever comes first. While the scanning mode is active, the predictions and corresponding images are shown in real time, along with the prediction confidence scores. To ensure smooth operation, process threading may be employed to make predictions concurrently, preventing any interruption to the RT eFAST application's functionality. The system processed one frame at a time, waiting for each prediction to finish before loading the next frame.

As part of the data collection feature, the program can save all frames captured between predictions. A results folder was generated for every scan, containing subfolders for the saved intermediate frames and one for the frames used for the predictions, a CSV file listing model predictions with confidence scores, and a TXT file with user-input comments. For guidance scans, predicted images were stored with overlaid object detection boxes.

### Ultrasound Image Filtering Features

Several filtering options are available to the user while scanning: bad frame removal, guidance filtering, and the option to turn both of these on at the same time. The bad frame removal filtering option performs an analysis of each image to quantify the quality of the image based on intensity-based and texture-based features before predictions are made. To attain this functionality, a sample of 2000 images was taken from each scan site in the dataset and then analyzed using noise and pattern analysis to find some correlation between the ultrasound images labeled “bad” and quantifiable characteristics, such as average pixel intensity, the standard deviation of pixel intensity, entropy, or the signal-to-noise ratio. Images were labeled “bad” by two US operators based on the quality of the image and the ability to make a diagnostic prediction from the image. The metrics that indicated the strongest correlation to image quality were the average and standard deviation of pixel intensity, corresponding to the brightness and contrast of the images, respectively. Using this analysis, the most ideal values for brightness, contrast, and the signal-to-noise ratio were selected as the parametric floor to classify an image as a bad frame. The user also has the option to adjust the aggressiveness of bad frame removal from the GUI by entering a multiplier value to be applied to the bad frame parameters. Bad frame removal was only used for the RUQ and BLD sites, as the M-mode capture process required multiple seconds of undisturbed data capture, making bad frame removal not possible during this capture process.

In addition to bad frame removal, a guidance filter as a second filtering option was developed. For this process, streamed frames were passed through the guidance model for the designated scan site before any predictions were made. The guidance AI models evaluated each image for the identification of relevant anatomical features, such as two ribs, a bladder, or a kidney. If these features were not detected, the GUI bypassed the frame and moved on to the next available frame without making a diagnostic AI prediction. For the rib models, guidance occurred at the start of the scan. Once two ribs were identified, the GUI prompted the user to hold still for M-mode capture until the scan was complete, whether it was real or generated. For the RUQ and BLD models, guidance was applied before each prediction, with the model only proceeding if the appropriate anatomical features were detected in the image. When both filters were active, images were passed through bad frame removal first, followed by guidance filtering.

Manual eFAST Exam with AI Model Guidance

A python script was developed to test the guidance and diagnostic AI models during a full eFAST exam, recording the time taken to complete each scan point. The script prompted the operator to follow a scan order of upper-left thorax, lower-left thorax, upper-right thorax, lower-right thorax, RUQ, and BLD. For each scan point, the user prompts, model predictions, and the times taken to complete each scan were displayed in the command terminal. At the lung scan sites, the guidance model for lungs ran until it detected two ribs, and then prompted the user to stay in that location while it made three predictions using generated M-mode images, before telling the user to move to the next scan point. For RUQ and BLD, the user had to swap to the curvilinear transducer and then the guidance model ran continuously, only making a diagnostic prediction when the kidney or bladder was detected, until it reached 30 predictions. This imaging application was run in two modes: one in which the operator viewed the ultrasound screen during the exam, and a second “blind” scan where the user was unable to see the display. The manual eFAST exam with RT AI predictions was performed at the timepoints specified in FIG. 23.

Automated Robotic US eFAST Exam

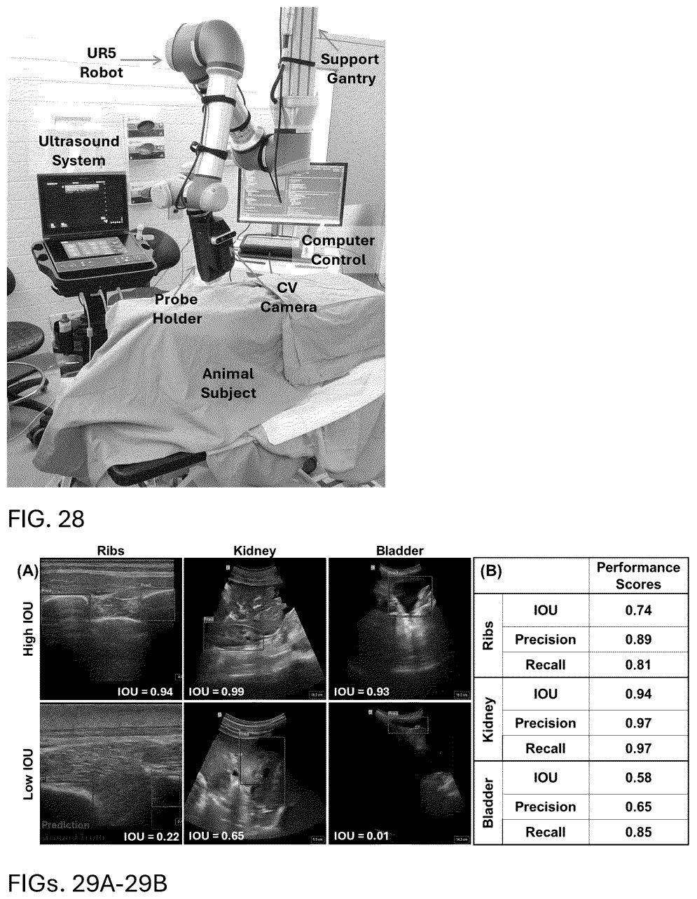

A UR5e robotic platform (Universal Robots, Odense, Denmark) is configured for semi-autonomous eFAST examination (FIG. 28). FIG. 28 provides an overview of an example robotic configuration for automated eFAST in swine. Relevant features of the setup are labeled to better explain the experimental setup.

The UR5e is programmed to navigate to eFAST scan sites using computer vision and stereo vision technology. Once at the scan site, the robotic arm is programmed to capture ultrasound images using a custom-made ultrasound probe holder to position the ultrasound probe and using integrated force feedback to apply the probe to the subject. Robotic navigation and image acquisition are further assisted by ultrasound-based guidance feedback that allows the robot to search a scan site at several positions until relevant anatomical features are in view of the image. Finally, the ultrasound images captured by the UR5e are evaluated for injury interpretation using the diagnostic AI models.

### Robotic Platform Configuration

The computer vision AI model detects the location of relevant scan sites on the subject's body using external image features. Ultrasound images are used to confirm the location of the relevant anatomical features for each scan site, and a fiducial target in the form of a circular color-coded sticker or other label is placed on the body of the subject at this location. The UR5e is programmed to travel around the body of the subject, capturing images using an Intel RealSense 435i camera (Intel, Santa Clara, CA, USA). Images are captured with and without the targets placed on the subject. eFAST scan sites are then labeled in MATLAB using the images that included targets. This process is repeated so that the image training dataset comprised images captured for two subjects. A computer vision model is then trained using YOLOv8s to accurately identify the color-coded stickers. Images of swine are also captured without stickers present to determine if the AI models could accurately identify scan sites without stickers present. Alternately, the computer vision models for detecting stickers at each scan site may be used. IOU scores were calculated for model predictions during the testing performed on the three swine subjects based on agreement between ground truth labeled sites and AI model prediction.

During testing, the UR5e is positioned over the subject at mid-torso using a hoist-lift structure (FIG. 28). The UR5e is programmed to capture four images of the top, left side, and right side of the pig using an Intel RealSense camera fixed to the end of the robotic arm, for example. For each image, the computer vision model detects the location of each scan site, providing the UR5e with real-world scan site coordinates for computer-vision enabled navigation. The model returned the pixel value of the center of the color-coded targets that were detected in each image. Next, with the inherent depth reading capabilities of the Intel RealSense camera associated with stereo vision technology, the real-world 3-dimensional location of the target relative to the lens of the camera is determined. The 3-dimensional location of the target is then transformed to the robot's coordinate system, allowing the robot to navigate to the scan site and apply the probe for image acquisition.

The quality of image acquisition is improved by using ultrasound image-based guidance feedback to scan a site, capturing multiple US images until an US image was acquired that could be used for proper diagnostic interpretation. For the abdominal sites, eight additional scan locations positioned in a circle equidistant apart at a 2.54 cm radial offset from the location of the original scan site, for example, were available for image capture. For the thoracic sites, the robot is programmed to scan linearly in intervals of 1.2 cm in the caudal direction before scanning another set of sites, following a line slightly offset in the same direction. This resulted in a total of 7 potential scan site positions for evaluation.

In addition to finding all the scan sites, radial positions, and linear positions on the subject, it was needed to ensure that the probe was oriented orthogonally and applied sufficient contact force to the surface to receive a clear ultrasound image. To do so, depths are measured at the detected scan point, so that the slopes of the measured surface can be used to calculate the correct roll, pitch, and yaw coordinates that would allow the robot arm to position the probe normal to the surface at each scan site. By accounting for the local curvature of the anatomy of the subject, adequate contact is sought between the surface of the ultrasound probe and the surface of the subject at each scan position. For the abdominal scan sites, a rocking B-mode scan is performed, where upon reaching an adequate position, the robot rotates to four different angles at a 5-degree offset relative to the scan site and collects a set of ultrasound frames at each different angle to pass to the diagnostic model. The set of ultrasound frames is acquired over a period of a tenth of a second for both the guidance and diagnostic scans, yielding between 5 and 7 frames.

Robotic eFAST (RoboFAST) Exam with AI Model Guidance

A set of three RoboFAST exams, each with a different set of criteria, in this example, are run on each of three experimental swine subjects at the two post-euthanasia timepoints (FIG. 23). All trained diagnostic and guidance AI models may be integrated into the RoboFAST algorithm to assess the robotic platform's capabilities and compare its performance to the manual eFAST exam performance. Upon detecting all scan sites and converting the pixel coordinates to coordinates relative to the origin of the robot, the robot starts the respective experimental run.

The first run, referred to as “Radar”, is a general eFAST exam where the robot scans both the original scan site and additional radial and linear positions until the guidance AI model returns that the proper organ or anatomy was present, indicating that a suitable location to run the diagnostic model was found. If no such detections occurred, the robot moves on to the next site without conducting a diagnostic prediction. However, when the guidance AI returns that the relevant object is detected, the diagnostic AI provides an injury prediction result for five consecutive frames. For the second run, referred to as “No Radar”, the robot performs a single image capture at the location where the colored sticker is detected. For the third experimental run, referred to as “All Radar”, the robot performs image capture at each scan site and all of the corresponding additional positions, running the diagnostic AI multiple times depending on how many positions at a site contained suitable locations. The plurality of what the diagnostic model returns then determines the prediction of the RoboFAST algorithm.

### Results—Guidance AI Performance

Referring now to FIGS. 29A, 29B, guidance AI performance for each anatomical location is shown, in accordance with various embodiments of the disclosure. FIG. 29A illustrates representative images for high and low IOU scores for rib, kidney, and bladder predictions. FIG. 29B illustrates testing performance scores for each anatomical guidance model for IOU, precision, and recall metrics.

For each guidance model trained, model performance was evaluated against a test dataset comprising images from subjects not included in the training data. Examples of high and low IOU scores are shown for each guidance model in FIG. 29A. The resulting average IOU scores varied across each model, with kidneys having the highest score at 0.94, followed by the ribs and bladder at 0.74 and 0.58, respectively, as shown in FIG. 29B. The precision and recall metrics were also strong for each guidance model, apart from precision for the bladder model, which was only 0.65 as shown in FIG. 29B. A higher false-positive rate due to the pixels being identified as bladder in the model's prediction but not in the ground truth image resulted in this lower score for the bladder model. Overall, each model was trained at variable performance levels and was able to correctly identify anatomical features to aid with proper eFAST US image acquisition.

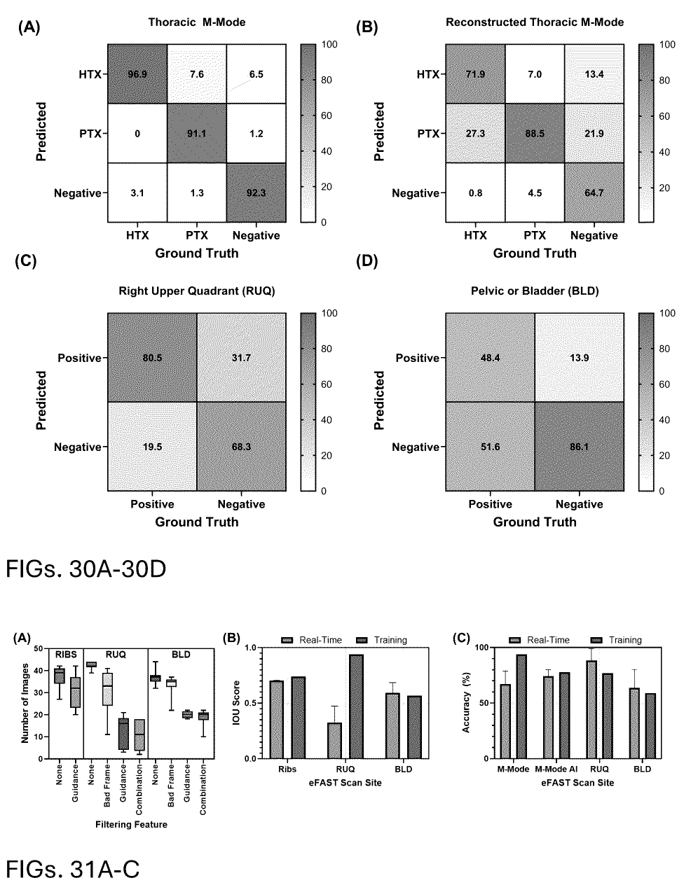

Referring now to FIGS. 30A-D, diagnostic AI confusion matrices for each diagnostic model are shown. FIG. 30A illustrates a three-class thoracic model using M-mode images. FIG. 30B illustrates a three-class thoracic model using M-mode reconstructed from B-mode frames. FIG. 30C illustrates a RUQ B-mode binary classification model. FIG. 30D illustrates a BLD B-mode binary classification model.

### Results—Diagnostic AI Performance

For thoracic diagnostic models, models were trained for both M-mode and generated M-mode diagnostic models (as described in Section 2.4.1). The M-mode diagnostic model predictions had a higher accuracy compared to the generated M-mode diagnostic models, at 0.94 vs. 0.78 accuracy, respectively. From the confusion matrix analysis, the generative M-mode models had a higher accuracy for the ground truth PTX predictions but identified 27% of the ground truth HTX images and 22% of the negative images as PTX (FIGS. 30A, 30B). Conversely, M-mode models had a slight bias toward HTX predictions, with 7.6% and 6.5% of the PTX and negative ground truth images being incorrectly identified as HTX-positive. Further RUQ and BLD diagnostic prediction models, binary in nature: positive or negative for abdominal hemorrhage, were developed. The RUQ models reached 0.77 accuracy but had a lower specificity metric of 0.68 compared to a higher recall of 0.80, hinting at slight bias toward positive predictions across the testing dataset shown in FIG. 30C. As for the BLD models, overall performance remained lower at 0.59 accuracy, with a much larger bias toward negative predictions in the testing dataset, as indicated by the confusion matrix and 0.49 recall metric as shown in FIG. 30D.

### Real-Time Model Performance

Real-time testing was conducted three different ways. The first used the RT eFAST application and was primarily used to evaluate the AI guidance and diagnostic model performance at each scan site, along with the utility of different filtering approaches. The other two approaches were the manual, handheld eFAST exam with AI model feedback and RoboFAST. Both of these approaches allowed for a full eFAST exam to measure the timing of the procedures and how the AI models synergized with various image acquisition approaches.

Evaluation of the Real-Time eFAST Application

Starting with the RT eFAST application, reference is made to FIGS. 31A-31C. FIGS. 31A, 31B, 31C illustrate an evaluation of a real-time eFAST application, in accordance with various embodiments of the disclosure. At FIG. 31A the total number of images captured at each scan location for a set 30 s capture window for various pre-processing filter methods is illustrated. Averages are shown along with the size of the box highlighting the 25th and 75th quartiles, while error bars denote minimum and maximum values. FIG. 31B illustrates performance IOU results for AI-guided manual US image capture compared to test performance results during model training. FIG. 31C illustrates diagnostic accuracy of real-time image capture compared to test accuracies during model training for each scan location. Mean values are shown with error bars denoting standard deviation.

It can be seen that the different filtering methods impacted the number of images that were captured at each scan site during a 30 s data capture window as shown in FIG. 31A. For ribs, on average, six less images were captured when using the guidance filter (approximately 37 vs. 31 images). Bad frame filtering was not applicable at this scan point due to M-mode capture needing to be continuous and not interrupted by frame removal procedures. The effects were more noticeable with RUQ and BLD, where bad frame filtering reduced the number of images by 12 and 3 images, respectively, while guidance filtering reduced the number of images by 30 and 16 images, respectively. Compounding these approaches reduced the number of images sent to the diagnostic models by 32 and approximately 18 images, respectively.

Next, how the guidance models performed using the RT eFAST application was evaluated. This was undertaken without any filtering methods applied to obtain an overall IOU performance metric for each scan site as shown in FIG. 31B. In real time, performance decreased for ribs (0.70 real time vs. 0.74 training) and more substantially for the RUQ (0.33 real-time vs. 0.94 training), while BLD performance slightly increased (0.59 real time vs. 0.57 training). In terms of diagnostics, the effects of these filters on overall diagnostic accuracy were minimal, so the averaged diagnostic accuracy results comparing training performance are shown in FIG. 31C. Performance was comparable to training data, with the exception of the M-mode thoracic model, which had a reduced accuracy of 0.67 compared to 0.94 during model training.

### RoboFAST Evaluation

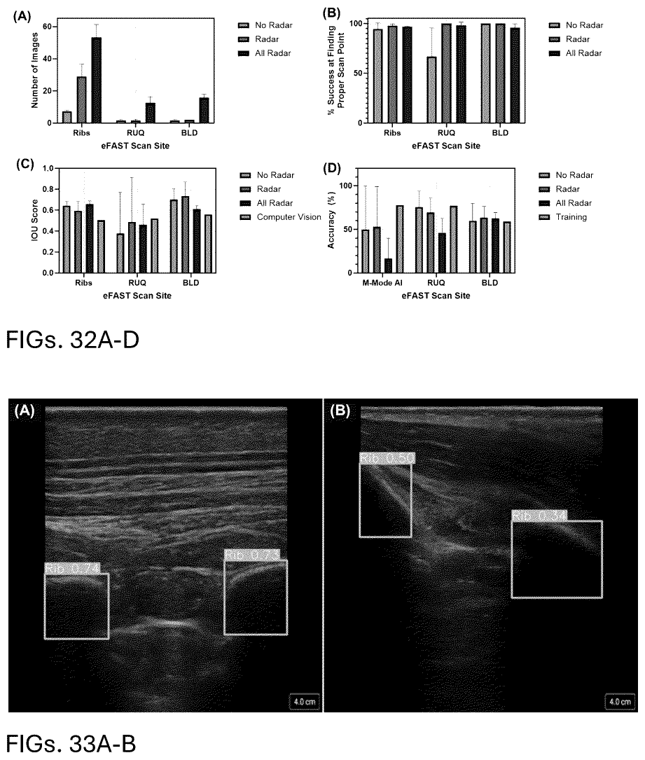

Referring now to FIGS. 32A-D, performance evaluation in swine is illustrated. In FIG. 32A, the number of images captured with each imaging modality with the robotic imaging platform is illustrated. In FIG. 32B, the overall success of RoboFAST in finding an US image to send to diagnostic AI models for each scan point and imaging modality is shown. FIG. 32C illustrates IOU performance results for guidance AI models using No Radar, Radar, and All Radar modalities; computer vision IOU scores for identifying scan sites are also shown for ribs, RUQ, and BLD positioning. FIG. 32D illustrates diagnostic accuracies for each scan modality compared to diagnostic model blind test accuracies during training. Averages are shown and error bars denote standard deviation across triplicate swine subjects throughout.

The robotic imaging platform relied on a computer vision model to identify each eFAST scan site automatically. The IOU scores for these predictions across scan sites were as follows: 0.51, 0.52, and 0.56 for ribs, RUQ, and BLD, respectively, as shown in FIG. 32C. For US image capture, three approaches were used to capture images, as described above, using the Robotic eFAST (RoboFAST) exam with AI model guidance: Radar, No Radar, and All Radar modalities. First the effects of the various methods on the total number of images captured was evaluated as shown in FIG. 32A. As anticipated, the All Radar approach captured the most images for each scan site, while No Radar and Radar had similar numbers of images for the RUQ and BLD scan sites. Next the overall success of each scan site across the three swine subjects was quantified, where success is defined as at least one image being captured that could be used for diagnosis as shown in FIG. 32B. All approaches had high performance, except for the RUQ/No Radar approach at 67% success. Factoring this in, Radar and All Radar had similar performance levels for this evaluation criterion. The guidance model IOU performance scores were similar for each RoboFAST imaging modality, with BLD having the highest IOU scores and RUQ performing the worst and having the highest subject variability as shown in FIG. 32C.

Lastly, diagnostic model performance was evaluated. The All Radar modality resulted in the lowest accuracy for the M-mode thoracic AI (16.5%) and RUQ (46%) models, as shown in FIG. 32D. Radar and No Radar performed similarly at each scan site. Compared to the test results obtained during model training, BLD and RUQ were comparable to the RoboFAST captured accuracies, while RoboFAST severely underperformed for the thoracic scan sites. This may be a result of the robotic imaging platform experiencing difficulty reaching the proper thoracic scan site where pleural space was present, as shown in the representative US images captured during RoboFAST, as shown in FIGS. 33A, 33B in which RoboFAST thoracic US images are illustrated. Representative US images captured by the robotic platform with pleural space in view in FIG. 33A and not in view in FIG. 33B.

Timing Comparison Between Handheld eFAST Application and RoboFAST

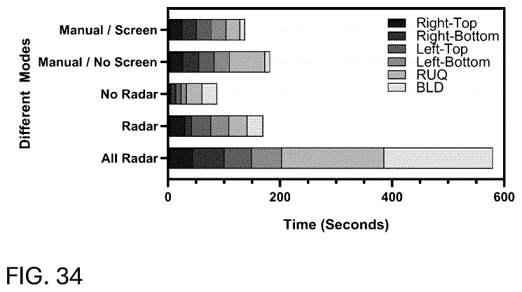

FIG. 34 illustrates a summary of eFAST image capture times. Results are shown for all scan sites evaluated for each configuration of the manual AI-guided and automated robotic image platform. Average results are shown for each scan site across triplicate animal experiments.

Ultimately, the overall time required to complete two RT eFAST imaging methodologies was compared as shown in FIG. 34. Instead of the RT eFAST application, the AI models were configured for use in sequence across six total scan locations to mirror how the images were captured with the robotic imaging platform: (i) right thoracic top and (ii) bottom, (iii) left thoracic top and (iv) bottom, (v) RUQ, and (vi) BLD, described above, matching the number of scan sites used during RoboFAST testing. The timing of image capture by the end user having or not having the US screen visible (only relying on AI predictions and instructions to move to the next scan site), which resulted in a slightly longer time on average with no screen visible compared to when the screen was present (138 s manual, screen vs. 183 s manual, no screen), was evaluated. The RUQ scan site was most impacted by not looking at the US screen, as most captured images were excluded by the guidance filter. For the robotic imaging platform, the No Radar modality was the quickest (87 s), with rapid thoracic image capture compared to the slower Radar image capture (170 s), and the overall slowest All Radar modality (580 s).

### Applications in View of the Above

As ultrasound technology becomes smaller and more portable, its potential utility in emergency medicine widens. Pre-hospital triage by US imaging may be possible if the challenges of imaging can be reduced so that less-skilled personnel can perform initial triage assessments. This is especially true for military medicine, where triage decisions in the battlefield must prioritize limited evacuation opportunities in scenarios where air evacuation is not readily available, as has been the case in recent conflicts. The AI-driven tools described herein demonstrate how US imaging can be simplified to lower the skill threshold for triage on future battlefields or in other civilian emergency situations.

Of interest is the automation of image acquisition techniques. Guidance object detection AI models were built using a YOLO model architecture, which was further tuned for use with swine datasets. Performance was mixed in the real-time implementation of these models, with BLD and RUQ underperforming compared to rib detection models. Nonetheless, this still highlights how guidance models could assist with real-time scanning. These models can be used as a filter during manual scanning to exclude all frames in which key anatomical features are not present. Additionally, they may be used to provide autonomous feedback to robotic image acquisition platforms to acquire images with evident anatomical features that are required for proper diagnostic interpretation. Refined models may ensure that not only anatomical features are present in the image, but also that the ideal anatomical features for diagnostic determination are identified. For instance, models confirmed the presence of two ribs in each image so that the pleural space between the ribs can be evaluated for diagnosis. However, if the probe is not oriented correctly, the pleural space cannot be seen, making injury identification impossible. Additionally, the model confirms the presence of a kidney in each image to evaluate RUQ scan sites. It is noted that since fluid often pools around the edges of the kidney, guidance models could confirm that the edges of the kidney are in view so that images used for diagnostic interpretation capture the area most likely to demonstrate evidence of injury.

Diagnostic AI models may be further refined prior to real-time application. US image sets expanded to more than 35 swine subjects allow for use a YOLOv8 image classification model. A likely reason for the difference in model performance, in which the guidance models were consistently more accurate compared to the new diagnostic models, is that the guidance models were required to identify anatomical landmarks, while the diagnostic models were tasked with the more difficult task of interpreting nuanced changes in variable injury sizes. Additional image curation, robust model architecture, and rigorous model fine-tuning will further improve AI training performance and the use of these models for real-time image interpretation. As for the methods of exploring model architectures, deep learning models used for segmentation can be applied to localize features of injury to help the models attribute the presence of fluid around the bladder, resulting in positive classifications. Long short-term memory (LSTM) networks used in video analysis can be explored to give the models more context on the appearance of variable injury sizes when making predictions on sequential images. Lastly, adding filters or pre-processing techniques with the purpose of amplifying relevant areas of the bladder can be tested for model training to help differentiate features between classifications.

AI models were evaluated in real time, with and without a robotic imaging platform, highlighting example, different end-user applications of this technology. The handheld manual AI-guided application had faster performance, but still requires a user to position the probe in the right location. Filtering approaches were used to exclude images that were not suitable for diagnostic evaluation, which resulted in the exclusion of a large number of images from the diagnostic pipeline. Image filtering is important for automated image acquisition in a handheld format, as less-experienced users may place the ultrasound probe at incorrect positions that may not have been included in diagnostic AI training datasets, resulting in a higher likelihood of incorrect diagnostic predictions. An alternative to making diagnostic models more robust to handle these irregular images is that filtering applications can prevent these images from impacting diagnostic predictions. Large datasets paired with modified diagnostic models will help the development of these filters and manual AI-guided eFAST image capture techniques.

For the robot image capture platform, different configurations had a wide impact on the speed of performing an eFAST examination, a result of the number of images being captured and the need to ensure that a proper eFAST viewpoint is captured at each scan site. A robot's limited range of motion may be challenged by the deeper angles required to image the RUQ or the lower thorax, where HTX injuries are often identified. This may be affected by the robot image capture platform configuration, such as the bulkiness of the platform and poor clearance with the table on which the subject was placed. Guidance models performed as expected; diagnostic model accuracies for the thoracic scan sites may be improved by gradual movement and better tracking of the proper direction to move across the thoracic cavity. Conversely, the RUQ and BLD had similar accuracy to the testing results of the diagnostic models, providing evidence of the utility of robotic mechanisms to automate image capture.

The utility of the handheld and robotic eFAST imaging platforms differ greatly in their potential applications. A large robotic system is not feasible in all pre-hospital settings but could be envisioned at a site for processing mass casualty scenarios, for automated triage assessment in a hospital, or military applications. Less human support is needed once the technology is further refined, so a more automated design can potentially streamline casualty in-processing. In direct contrast, the handheld tool, if paired with small, portable US devices, could be deployed in ambulatory civilian care or military care near the point of injury. While the technology will still require the user to manipulate the technology to proper positions, additional guidance measures in the software application can further lower the skill threshold during real-time deployment.

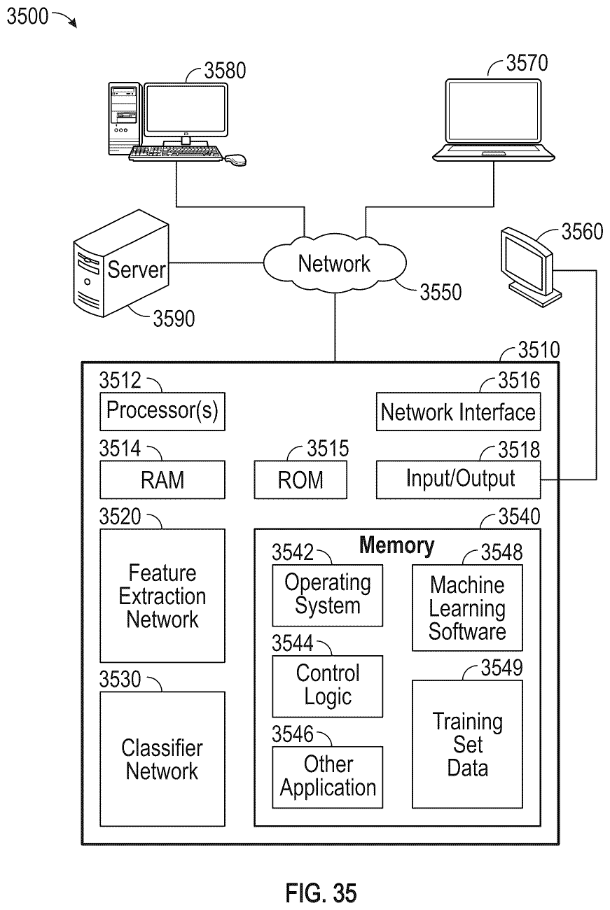

FIG. 35 illustrates a system block diagram 3500 including an example of a computing device 3510, such as the external video display device discussed above, that may be used in implementing one or more features of the disclosure, in accordance with embodiments of the present disclosure. Computing device 3510 may, in some embodiments, implement one or more aspects of the disclosure by reading and/or executing instructions and performing one or more actions based on the instructions. In some embodiments, computing device 3510 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device. Further, as discussed previously, the video display device may comprise any machine configured to perform processing and/or calculations, may be but is not limited to a work station, a server, a desktop computer, a tablet computer, computing devices, a server farm, remote or wired machine, a personal data assistant, a smart phone, or any combination thereof, see FIG. 35. Moreover, as previously described, a server may be any server type such as, for example: a file server; an application server; web server; proxy server; an appliance; a network appliance; a gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or balancing functionality.

As the software utilizes the processor and memory of an external video display device to function, the algorithm can be executed online or offline. The algorithms used herein has the built-in ability to configure video processing of the graphing processing unit (GPU) usage along with the computer processing unit (CPU) usage to utilize machine resources to execute the tasks described. It is understood that the described platform can be implemented using any computing technique, e.g., as a stand-alone system, a distributed system, within a network environment, etc. All processing of the algorithm model is preferably processed on the external screen device. In these embodiments, the software application does not rely on cloud services for image detection and deployment of algorithm.

Computing device 3510 may, in some embodiments, operate in a standalone environment. In others, computing device 3510 may operate in a networked environment. As shown in FIG. 35, computing devices 3510, 3570, 3580, and 3590 may be interconnected via a network 3550, such as the Internet. Other networks may also or alternatively be used, including private intranets, corporate networks, LANs, wireless networks, personal networks (PAN), and the like. Network 3550 is for illustration purposes and may be replaced with fewer or additional computer networks. A local area network (LAN) may have one or more of any known LAN topologies and may use one or more of a variety of different protocols, such as Ethernet. Devices 3510, 3570, 3580, and 3590 and other devices (not shown) may be connected to one or more of the networks via twisted pair wires, coaxial cable, fiber optics, radio waves or other communication media. As seen in FIG. 35, computing device 3510 may include a processor 3512, RAM 3514, ROM 3515, network interface 3516, input/output interfaces 3518 (e.g., keyboard, mouse, display, printer, etc.), and memory 3540. Processor 3512 may include one or more computer processing units (CPUs), graphical processing units (GPUs), and/or other processing units such as a processor adapted to perform computations associated with machine learning. I/O 3518 may include a variety of interface units and drives for reading, writing, displaying, and/or printing data or files. I/O 3518 may be coupled with a display such as display 3560.

Memory 3540 may store software for configuring computing device 3510 into a special purpose computing device in order to perform one or more of the various functions discussed herein. Memory 3540 may store operating system software 3542 for controlling overall operation of computing device 3510, control logic 3544 for instructing computing device 3510 to perform aspects discussed herein, machine learning software 3548, training set data 3549, and other applications 3546. Control logic 3544 may be incorporated in and may be a part of machine learning software 3548. In other embodiments, computing device 3510 may include two or more of any and/or all of these components (e.g., two or more processors, two or more memories, etc.) and/or other components and/or subsystems not illustrated here. Moreover the device has a feature extraction network 3520 and a classifier network 3530.

As previously described, the memory may be any storage devices that are non-transitory and can implement data stores, and may compromise but are not limited to an optical storage device, a solid-state storage, hard disk drive, or any other magnetic medium, a ROM (Read Only Memory), a RAM (Random Access Memory), a cache memory and/or any other memory chip or cartridge, and/or any other medium from which a computer may read data, instructions, and/or code.

Devices 3570, 3580, and 3590 may have similar or different architecture as described with respect to computing device 3510. Those of skill in the art will appreciate that the functionality of computing device 3510 (or device 3570, 3580, and 3590) as described herein may be spread across multiple data processing devices, for example, to distribute processing load across multiple computers, to segregate transactions based on geographic location, clinician access level, quality of service (QoS), etc. For example, computing devices 3510, 3570, 3580, 3590, and others may operate in concert to provide parallel computing features in support of the operation of control logic 3544 and/or machine learning software 3548.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

### Deep Learning Models for Real-Time Thoracic Ultrasound Image Interpretation

Thoracic injuries account for a high percentage of combat casualty mortalities, with 80% of preventable deaths resulting from abdominal or thoracic hemorrhage. Deep learning (DL) models for classifying images as showing HTX or PTX injury, or being negative for injury are disclosed herein for lowering the skill threshold for POCUS diagnostics on the future battlefield or other medical environment. Three-class deep learning classification AI models were developed using a motion-mode ultrasound dataset captured in animal study experiments from more than 25 swine subjects. Cluster analysis was used to define the “population” based on brightness, contrast, and kurtosis properties. A MobileNetV3 DL model architecture was tuned across a variety of hyperparameters, with the results ultimately being evaluated using images captured in real-time. Different hyperparameter configurations were blind-tested, resulting in models trained on filtered data having a real-time accuracy from 89 to 96%, as opposed to 78-95% when trained without filtering and optimization. The best model achieved a blind accuracy of 85% when inferencing on data collected in real-time, surpassing previous YOLOv8 models by 17%. AI models are suitable for high performance in real-time for thoracic injury determination and are suitable for potentially addressing challenges with responding to emergency casualty situations and reducing the skill threshold for using and interpreting POCUS.

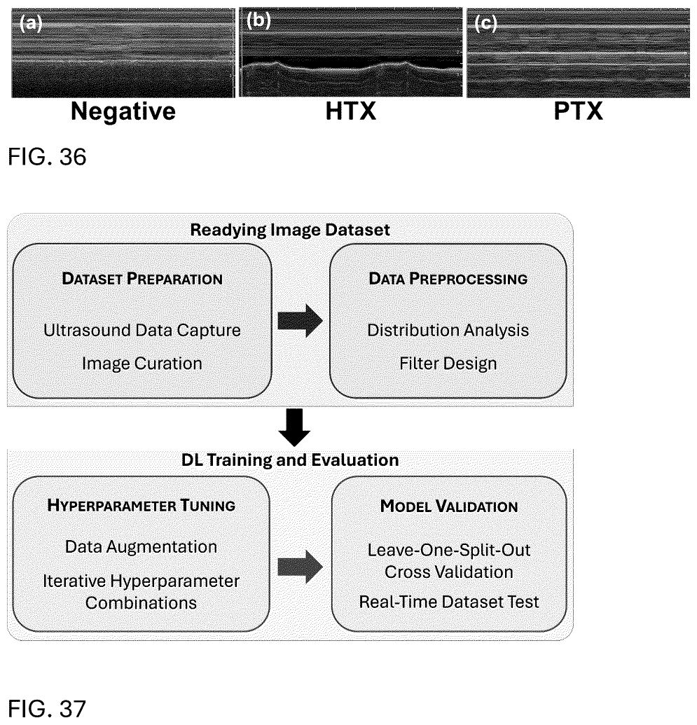

A large swine US image dataset was captured for the thoracic and abdominal cavities with varying injury states for training deep learning (DL) models for DL classification. From this dataset, multi-class and binary classification models were developed for scan sites using custom-developed convolutional neural networks (CNNs) and CNN classification architectures. A recently conducted animal study explored the real-time performance of three-class thoracic motion mode (M-mode) models to distinguish between negative for injury (or baseline), pneumothorax (PTX), and hemothorax (HTX); example M-mode images for each class are highlighted in FIG. 36. FIG. 36 shows representative motion mode (M-mode) US images of relevant thoracic region injury states. Images shown include for baseline or negative for injury (a); hemothorax or HTX (b); and pneumothorax or PTX (c). However, performance was significantly reduced during real-time implementation, with accuracies only reaching 67% for this thoracic application.

As described herein, the real-time performance of DL models for thoracic detection of PTX and HTX injuries is improved. Specifically, the utility of thoracic M-mode diagnostic AI suitability in real-time is demonstrated, ultimately for pairing with POCUS equipment in a far-forward environment, thereby filling a need to improve three-class M-mode POCUS image interpretation with suitability for real-time use cases. The contributions of this study are as follows:
Additional swine data curation was implemented for a more robust dataset compared to previous studies.
The filtering methods of the dataset were designed from the results of image preprocessing and analysis to correct data distribution shifts.
A multi-class DL CNN was developed and optimized to classify ultrasound images as uninjured, HTX, or PTX.
The model performance was evaluated with real-time data captures to highlight how the advancements improved performance when compared to previous studies.

### Materials and Methods

This section is organized into two main parts-readying the image dataset and DL model training and evaluation-following the block diagram depicted in FIG. 37. FIG. 37 is a block diagram summarizing study methods using during the thoracic study, in accordance with embodiments of the present disclosure, in which each subsection includes a detailed description of the phases of the study highlighted in this diagram.

The dataset referred to in this example is comprised of thoracic ultrasound (US) scans from previously captured swine US datasets. Research was conducted in compliance with the Animal Welfare Act, implementing Animal Welfare regulations, and with the principles of the Guide for the Care and Use for Laboratory Animals. Live animal subjects were maintained under a surgical plane of anesthesia and analgesia throughout the studies. Data were mainly captured at two time points: after subject instrumentation and post-euthanasia.

Dataset curation labels included animal subject ID, injury state, injury severity, signal quality index, and transducer steadiness; other labels could be employed. The injury severity for the HTX and PTX classes was graded by magnitude of injury as “positive” or “slight”. Signal quality index used a Likert scale to rank data based on whether the relevant anatomical features were in view, with 1 corresponding to poor quality and 5 representing best quality. If the US capture was noisy due to motion artifacts, this was noted. Subjective metrics such as steadiness and signal quality index were scored by two reviewers involved in US image capture. Only signal quality scores of 3 or above without motion artifacts were used for DL model development.

### Data Preprocessing

The entire dataset was split evenly across each animal protocol into three groups for the leave-one-split-out (LOSO) cross validation setup. The three groups were analyzed for image property distribution before training any DL model. This is unlike previous work in which this analysis was not performed prior to implementing the LOSO cross validation methodology.

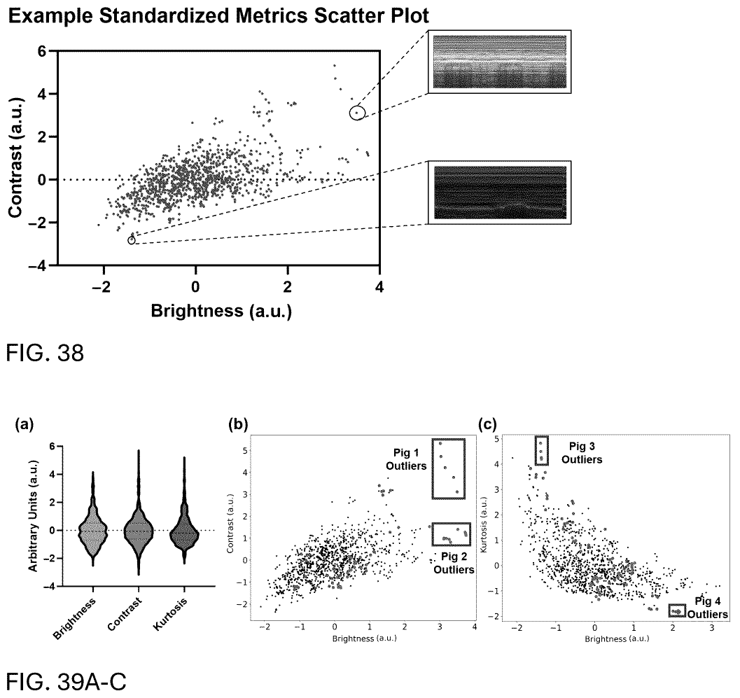

Distribution analysis was performed to identify image-level and group-level differences, using Python libraries scikit-learn (ver. 1.5.1) and Matplotlib (ver. 3.8.3) on Python 3.11.7. The images were analyzed for standard image properties: brightness (B), or the average pixel intensity of the image, contrast (C), or the standard deviation of the pixel intensities of the image, and kurtosis (K), or the pixel intensity distribution of the image. Pixel intensity metrics were calculated and normalized using Z-standardization to plot and observe the relationship between the metrics of the images for the entire distribution of US captures. The evaluated metrics were plotted against each other on two-dimensional plots to observe differences between the images using contrast vs. brightness and brightness vs. kurtosis plots. An example of outlier US scans is shown in FIG. 38, in which a representative standardized metric scatter plot with corresponding US captures is illustrated. Selected US captures are shown from the corresponding data points in the scatter plot.

A confidence interval was defined on the US captures as a region within the Mahalanobis distribution of captures. The squared Mahalanobis distances, or the distances between a US capture and its distribution, were calculated using the covariance of the metrics. Then, using the cumulative distribution function of the squared Mahalanobis distances, different confidences were evaluated to see US captures that were within the distribution. After choosing a confidence interval of 97.7%, labels for the dataset were generated depending on which data points fit within the interval, acting as a filter for the dataset. This step was performed on the two metric relationships: C vs. B and B vs. K.

### DL Model Training and Evaluation

A training pipeline was created for US image label compilation that applied filter processing, configured the DL model architecture with data augmentations, and set up model training with different combinations of hyperparameters. DL model development was conducted with the PyTorch (ver. 2.2.0) framework using augmentation transformations to prevent overfitting, including a 50% probability that the image will be flipped, a brightness adjustment defined within 40% to 140% of the baseline value, and a contrast adjustment within 95% to 130% of the baseline contrast. The model architecture chosen for training was MobileNetV3, due to previous success with utilizing MobileNetV2 architecture to train binary classification models for injury interpretation. For all training iterations, ImageNet1 kV1's pre-trained weights were used as a starting point with the MobileNetV3 architecture. By default, the MobileNetV3 architecture defines its classifier with 1000 outputs or classes as per the ImageNet dataset. The fourth layer of the classifier that defines output size was replaced with a linear layer to define three outputs for the negative, HTX and PTX classes, thus changing the output of the dense layer. Training iterated over group splits for LOSO cross validation. DL models were trained on a 70:20:10 split of data for training, validation, and testing per LOSO fold. The accuracy of each LOSO fold was evaluated after the training and validation processes, using the sci-kit learn library to generate confusion matrices and accuracies for classifications.

### Hyperparameter Tuning

Based on previous studies, 100 training epochs with a batch size of 32 were used, as this is generally considered a good balance between variance in gradient estimates and convergence speed for computational efficiency. A learning rate of 0.001 was chosen for training. Once training finished, the results and metadata regarding the LOSO folds were saved. This was repeated for all iterations of training for each preprocessing filter. In combination with filter group options, different hyperparameters were tested, such as weighted loss, validation patience, and weighted decay. Combinations of these hyperparameters were tested iteratively until a target testing accuracy of 85% across all LOSO folds was met. To account for class imbalances in the dataset, weighted loss was applied by calculating the frequency of classes per label and deriving a class weight inversely proportional to the frequency of the class using the sci-kit learn library. From this, the classes with lower frequency were given more weight during training to address the class representation imbalance of the dataset. Performance metrics were calculated with blind test data, with accuracy being calculated two ways-balanced and global accuracy. Balanced accuracy normalizes weights for each classification, while global accuracy does not account for class imbalances among HTX, PTX, and negative.

### Real-Time Testing

To further validate the performance and inference capabilities of the trained models, a Python script was developed to obtain US video captures, crop videos, and extract frames to inference the DL models while simulating real-time deployment on blind test images. Frames were extracted at 30 frames per second from the 10 s in the middle of each 30 s US video. The accuracy of each LOSO model was compared against prior YOLOv8 image classification-trained thoracic models, which were evaluated in real-time during large animal studies. In addition, Gradient-weighted Class Activation Mapping (GradCAM) overlayed images were generated to show gradient hotspots for image regions of importance to AI predictions, to highlight model explainability.

### Cluster Analysis Results

The first analysis conducted evaluated the effects of preprocessing analysis for image filter development. FIGS. 39A-39C illustrate standardized metric plots with pig labels, in accordance with embodiments of the present disclosure. FIG. 39A illustrate violin plots highlighting the data distribution for brightness, contrast, and kurtosis. Dashed lines for the median and first and third quartile for each metric are shown. FIG. 39B is a contrast and brightness plot highlighting US captures that belong to Pig 1 (dark pink) and Pig 2 (teal), with outlier groups (black boxes). FIG. 39C shows a Kurtosis and brightness plot highlighting groups of US captures that belong to Pig 3 (teal) and Pig 4 (dark pink), with outlier groups (black boxes). The overall property distributions of the brightness (B), contrast (C), and kurtosis (K) metrics used for filter development are shown in FIG. 39A. From the C vs. B relationship, it is clear that some US captures were separated as outliers from the rest of the population of the dataset as shown in FIG. 39B.

Highlighted in the C vs. B plot are two subjects with a cluster of US scans that are outliers to the standard image distribution. These images were substantially brighter/dimmer, and their variability could impact model training generalizability. Similarly, in FIG. 4c, additional US captures based on swine subjects were identified as outliers from the standard population based on K vs. B relationship trends. Lastly, the K vs. C relationship trends had a similar distribution to the K vs. B plot, and therefore were not used for preprocessing methods in this study.

After testing different intervals for a confidence ellipse, it was found that a confidence interval of 97.7% excluded outliers while minimizing the loss of informative, representative captures. Next, FIG. 5a,b illustrates how the selected confidence interval established the general shape of the confidence ellipse and which data points were filtered out of the ellipse based on their location on the plot. FIG. 5a shows how images with brightness and contrast outside of the 97.7% confidence interval (approximately 2 arbitrary units [a.u.] from the centroid) were excluded. Many images with low contrast and brightness were still within the confidence ellipse, and were thus included via this C vs. B filter. From FIG. 5a, images that were significantly high either in brightness (2.5 a.u.) or in contrast (2.8 a.u.) were not considered fit for the K vs. B ellipse based on the 97.7% confidence intervals defining the ellipse shape.

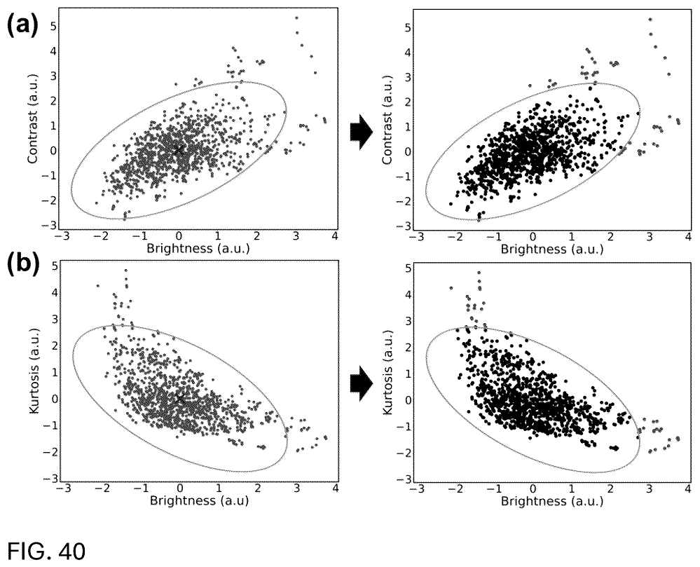

Referring now to FIG. 40, plots of image metrics with corresponding confidence ellipse filter are illustrated, in accordance with embodiments of the present disclosure. (a) Contrast vs. brightness metrics and (b) kurtosis vs. brightness metrics are illustrated. (Left image). Standardized metrics are plotted for each thoracic M-mode US (red dots) with the calculated centroid (blue “x”) and confidence ellipse overlayed (bright green). (Right image) Differentiates the US captures that are within the confidence ellipse (black) and which corresponding US captures are excluded from the filter (red).

### AI Model Development

AI models were developed using LOSO cross validation with a range of hyperparameter settings to identify which model setup performed best with real-time (RT) datasets. A summary of model performance for global and balanced accuracy across all hyperparameter configurations and filters is shown in Table 1, a summary of the model accuracy for each hyperparameter configuration. Results are shown for balanced and global accuracy as average and standard deviation across each LOSO split. Bolded rows indicate the highest performing hyperparameter configurations. The best-performing models using a C vs. B filter scored a global accuracy of 84.74%, with an average balanced accuracy at 90.49%. In comparison, the best-performing models that used no filter scored average global and balanced accuracies of 86.63%, and 88.17%, respectively. Conversely, the least accurate model from the average scored a balanced accuracy of just 78.63%.

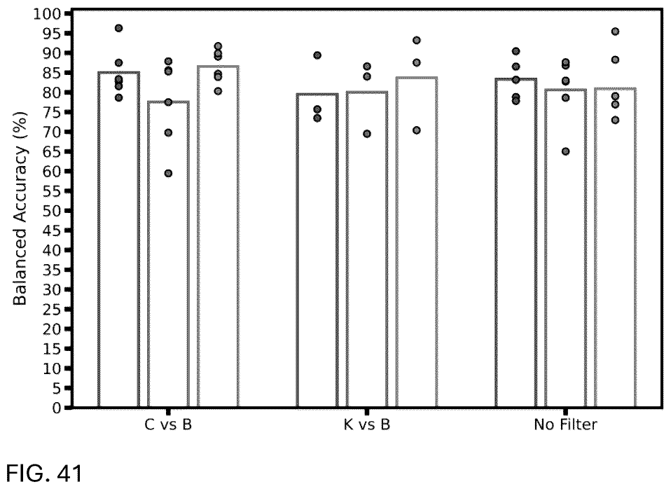

Next, balanced accuracy model performance was compared within each LOSO fold, per preprocessing filter used, as shown in FIG. 41. FIG. 41 illustrates a balanced accuracy model performance plot, in accordance with embodiments of the present disclosure. Real-time performance of models by group of filters by LOSO; each data point represents a different model trained, with the corresponding LOSO fold (N=3) shown as different colors. The hollow bar plot represents the average of all models trained for each LOSO across each group of filters. “No Filter” models achieved high accuracies above 85% in several LOSO models, with LOSO fold 3 achieving 95% balanced accuracy, most notably for one model configuration. With the C vs. B filter, the highest-performing model achieved over 95% balanced accuracy, and the average performance for LOSO folds 1 and 3 were higher than the “No Filter” group. However, C vs. B also had the poorest scoring model, from LOSO fold 2, at 59% balanced accuracy.

From the real-time performance results illustrated in Table 1 and FIG. 41, the LOSO models with the best average balanced accuracy were selected. In this case, models that used the C vs. B filter, 10 epoch validation patience, balanced weighted loss, and a 0.00001 weighted decay value achieved the best average balanced accuracy, of 90%.

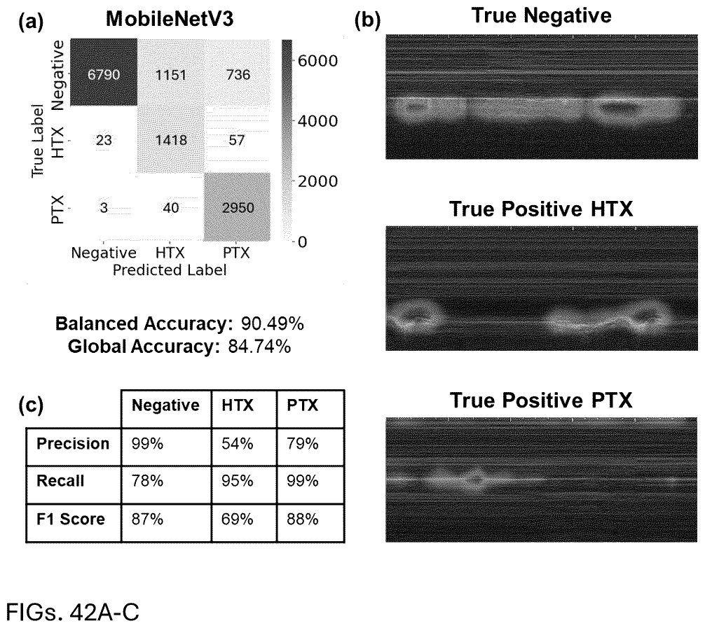

FIGS. 42A, 42B, 42C illustrate real-time performance visualization metrics, in accordance with embodiments of the present disclosure. In FIG. 42A, three-class confusion matrix of the three LOSO models evaluated for the model with best balanced accuracy. Confusion matrix for blind-streamed results predicted US captures exported from 44 streamed videos. About 300 frames were extracted per video to represent 10 s of capture. FIG. 42B shows representative GradCAM visualizations from LOSO fold 1 predictions for true negative, true positive HTX, and true positive PTX cases. FIG. 42C is a summary table of precision, recall, and F1 score metrics for each classification label.

FIG. 42A reflects the evaluation of the best performing model on 8677 negative images, 1498 HTX images, and 2993 PTX images, averaged across three LOSO folds. The classification imbalance was accounted for by including the weighted loss hyperparameter mentioned in Section 3.2.1, in order to give more weight to the captures with less frequency in the dataset. For the negative class, the models correctly identified negative classes for 6790 captures; however, they incorrectly predicted HTX or PTX for the other 1887 negative captures, resulting in a recall of 78% (FIG. 42C). The models incorrectly predicted false positive results for 26 captures for the negative class, scoring a precision of 99%. In the HTX class, true positive predictions were made for 1418 captures, achieving a recall of 95% and a low precision of 54%. The PTX class yielded a recall score of 99% and a precision of 79%, as most of the PTX captures were correctly identified, and some of the PTX predictions were made on the negative captures.

Model predictions were assessed using GradCAM overlays for each correct class prediction (FIG. 42B). For the negative class, the model is evaluating predictions by observing the lung motion due to breathing under the pleural line. The HTX true positive GradCAM overlay observes the dark space above the pleural line, tracking along the area where fluid would accumulate physiologically. Lastly, the PTX true positive GradCAM overlay closely tracks the pleural line, with some bias towards the top of the image due to tracking the x-axis tick marks.

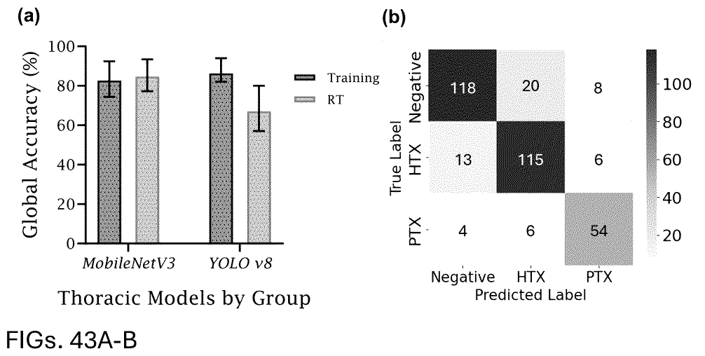

Next, the differences between training and real-time testing accuracy for the best-performing model were compared to models developed in a previous study, shown in FIGS. 42A, 42B. FIGS. 43A, 43B illustrate comparison of training and real-time accuracy for M-mode DL classification models, in accordance with embodiments of the present disclosure. FIG. 43A illustrates training vs. real-time (RT) global accuracy, grouped by model architecture used in this study (MobileNetV3) and a former study (YOLOv8). Average training performance is denoted with an error bar for each group denoting standard deviation (n=3). FIG. 43B illustrates MobileNetV3 training averaged LOSO confusion matrix.

There was a large discrepancy between the previous study's training and real-time performance, with the real-time being 19% worse than the training accuracy, at 86%. For this study, the training accuracy for global accuracy scored lower, at 83%, but the real-time scoring was consistent at 85%, highlighting the model's improved generalization for this application. Between training and real-time streamed M-mode results, there was a notable difference of 6.82% between average balanced accuracy in training and real-time evaluations, whereas the difference in global accuracy was less than 2%.

### Review of Results

In previous DL model development, there was a large disparity between real-time and training accuracy, highlighting the need to develop more generalized DL models. To address this, the focus was on improved image analysis preprocessing techniques and model training parameters were incorporated to counteract some of the limitations of the dataset, which previously did not explore for thoracic scan sites. Real-time performance increased to 86%, compared to a previous result of only 67%, by implementing the above improvement. Blind test performance was significantly improved in this study, suggesting that the filters and hyperparameters used helped the models with better generalization for this thoracic image classification application.

Of note, there were differences between failure cases for MobileNetV3 during training and real-time use. During training (FIG. 43B), MobileNetV3 had strong recall scores for each of the three prediction classes, each above 80%. The lowest precision metric was PTX, with 14 false positives compared to 54 true positive predictions. In real time, recall remained high, with HTX and PTX having stronger scores, while the score for the negative class slightly dropped from 81% to 78%. False class identification for negative images was skewed towards HTX over PTX. Larger changes were evident with precision metrics. Negative precision was significantly improved, and PTX remained the same. However, HTX dropped from 82% to 54%, primarily due to false positive HTX predictions from true negative class images.

Without the use of a preprocessing filter, a weighted loss function, or regularization, the LOSO folds performed with an average global accuracy of 88%, although with lower precision and recall, indicating bias towards predicting the negative class. There were fewer data for HTX and PTX compared to negative US captures; therefore, global accuracy is skewed toward the negative class. After using the preprocessing C vs. B filter and tuned DL model hyperparameter functions, significant improvements were found in average recall or “balanced” accuracies for each model. This indicates that having an applied confidence region for US scan metrics helped the model train and learn appropriate features representing the population. Weighted loss was integrated in model training as a function of loss to mitigate the effects of class imbalance and help prevent overfitting, which was apparent when weighted loss was not used. Overall, the C vs. B filter was more effective than the K vs. B filter. This may be due to kurtosis as a textural metric not correlating as well as brightness or contrast-intensity metrics-when it comes to the features in the M-mode thoracic US and how their intensity values change when there is air or blood present in the pleural space for the injury-positive classes.

While some hyperparameter tuning and filter preprocessing techniques were tested, there are other potential techniques that may help the models achieve higher performance. For example, for the context of this study and the importance of inference speed of the models, MobileNetV3 was chosen, since it is lightweight, and thus significantly faster at making predictions than other comparable architectures. With the methods and preprocessing techniques developed from this study, other models using Bayesian optimization strategies can be employed.

Next, fixed weights for the weighted loss of each class can be explored to evaluate for any model performance improvements, instead of using a function that calculates this based on input frequency. In addition, the only metrics used for creating the filters were brightness, contrast, and kurtosis; however, other kinds of image-based metrics can be prepared to help identify other symptoms of a shift in data distribution. While each of these approaches may improve training accuracy, the developed models nonetheless surpassed the target accuracy for this application of 85%. This blind accuracy is comparable to other studies for detection of lung motion from M-mode images that have achieved 82.4% in real-time clinical images or 89% accuracy when paired with segmentation models. A uniqueness of the models trained in this study is that they can differentiate between three injury states, classifying US M-mode images in three classes-HTX, PTX, and injury-negative.

It can be readily seen that image classification DL models can improve the utility of ultrasound implementation for improving medical imaging-based triage for emergency medicine and prehospital applications. Implementation, however, requires DL models suitable for removing outlier data and generalized to a wide variety of use cases for real-time application. By evaluating the characteristics of thoracic M-mode US captures, this effort determined that there was value in implementing additional preprocessing techniques and model parameter functions to reduce variability in performance. Results including maintaining an average balanced accuracy of 90.49% and an average global accuracy of 84.74%, which demonstrates the models' utility to resolve some of the challenges with making thoracic injury diagnostics in a pre-hospital setting. With these models running on a MobileNetV3 architecture, streamlining a diagnostic procedure with fast inferencing time in a pre-hospital setting can be especially useful for improving triage efforts.

Ultrasound imaging can revolutionize medical triage in trauma cases when used where the first medical decisions need to be made in both civilian and military medicine for optimal results. The real-time AI-driven triage tools described herein have the potential to lower the skill threshold of image-based triage decisions. The handheld application has a small footprint optimal for ease of deployment in which the end user can position the ultrasound probe correctly and make proper image interpretation decisions. The robotic-driven image capture application further automates the procedure but with a larger size, which may not be suitable in the earliest phase of trauma medical care. In conclusion, both applications provide evidence of the promise AI can provide to simplify medical imaging and improve medical triage decisions on the future battlefield and in pre-hospital settings.

The example and alternative embodiments described above may be combined in a variety of ways with each other without departing from the invention.

Embodiments of the invention have been described to explain the nature of the invention. Those skilled in the art may make changes in the details, materials, steps and arrangement of the described embodiments within the principle and scope of the invention, as expressed in the appended claims.

While implementations of the disclosure are susceptible to embodiment in many different forms, there is shown in the drawings and will herein be described in detail specific embodiments, with the understanding that the present disclosure is to be considered as an example of the principles of the disclosure and not intended to limit the disclosure to the specific embodiments shown and described. In the description above, like reference numerals may be used to describe the same, similar or corresponding parts in the several views of the drawings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive. Also, grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth. References to items in the singular should be understood to include items in the plural, and vice versa, unless explicitly stated otherwise or clear from the text.

Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” “for example,” or the like) provided herein, is intended merely to better illuminate the embodiments and does not pose a limitation on the scope of the embodiments. No language in the specification should be construed as indicating any unclaimed element as essential to the practice of the embodiments.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

In the following description, it is understood that terms such as “first,” “second,” “top,” “bottom,” “up,” “down,” “above,” “below,” and the like, are words of convenience and are not to be construed as limiting terms. Also, the terms apparatus, device, system, etc. may be used interchangeably in this text.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A method for automating eFAST analysis of ultrasound scans, the method comprising:
receiving at least one ultrasound image from one or more scan sites;
processing the at least one ultrasound image to determine whether there is a presence of one or more fluid pockets or free fluid present in the patient, more particularly the injury is selected from pneumothorax, hemothorax, and abdominal hemorrhage;
outputting a result from the processing,
where the model is trained on a plurality of historical ultrasound images over a historical observation period, the historical ultrasound images associated with at least one injury determined directly observed presence of a fluid pocket or free fluid present in those images.

2. The method according to claim 1, further comprising during training removing poor quality ultrasound images based on statistical analysis of the average pixel brightness, contrast, and signal to noise ratio.

3. The method according to claim 1, further comprising splicing vertical lines from a center of ultrasound image to create custom M-mode ultrasound image from a B-mode ultrasound image.

4. The method according to claim 1, further comprising during training using a leave-one-subject-out methodology to divide available ultrasound images into groupings to facilitate model training and validation based at least in part on the location of the scan site.

5. The method according to claim 1, further comprising using an object detection model to identify skeletal structure within the patient.

6. A non-transitory computer-readable medium carrying one or more sequences of instructions for automating eFAST analysis of ultrasound scans, where the execution of the one or more sequences of instructions by one or more processors causes the one or more processors to perform:
receiving at least one ultrasound image from one or more scan sites;
processing the at least one ultrasound image to determine whether there is a presence of one or more fluid pockets or free fluid present in the patient, more particularly the injury is selected from pneumothorax, hemothorax, and abdominal hemorrhage,
outputting a result from the processing, and
where the model is trained on a plurality of historical ultrasound images over a historical observation period, the historical ultrasound images associated with at least one injury determined directly observed presence of a fluid pocket or free fluid present in those images.

7. The medium according to claim 6, further comprising splicing vertical lines from a center of ultrasound image to create custom M-mode ultrasound image from a B-mode ultrasound image.

8. The medium according to claim 7, further comprising using an object detection model to identify skeletal structure within the patient.

9. The medium according to claim 6, further comprising using an object detection model to identify skeletal structure within the patient.

10. A system comprising:
at least one processor; and
at least one memory including one or more sequences of instructions,
the at least one memory and the one or more sequences of instructions configured to, with the at least one processor, cause the apparatus to perform at least the following:
receiving at least one ultrasound image from one or more scan sites into memory;
processing the at least one ultrasound image to determine whether there is a presence of one or more fluid pockets or free fluid present in the patient, more particularly the injury is selected from pneumothorax, hemothorax, and abdominal hemorrhage; and
outputting a result from the processing,
where the model is trained on a plurality of historical ultrasound images over a historical observation period, the historical ultrasound images associated with at least one injury determined directly observed presence of a fluid pocket or free fluid present in those images.

11. The system according to claim 10, further comprising during training removing poor quality ultrasound images based on statistical analysis of the average pixel brightness, contrast, and signal to noise ratio.

12. The system according to claim 11, where the sequence of instructions further including splicing vertical lines from a center of ultrasound image to create custom M-mode ultrasound image from a B-mode ultrasound image.

13. The system according to claim 11, further comprising during training using a leave-one-subject-out methodology to divide available ultrasound images into groupings to facilitate model training and validation based at least in part on the location of the scan site.

14. The system according to claim 11, where the sequence of instructions further including using an object detection model to identify skeletal structure within the patient.

15. The system according to claim 11, further comprising a linear ultrasound probe and/or a curvilinear ultrasound probe in communication with the at least one memory.

16. The system according to claim 10, where the sequence of instructions further including splicing vertical lines from a center of ultrasound image to create custom M-mode ultrasound image from a B-mode ultrasound image.

17. The system according to claim 16, further comprising during training using a leave-one-subject-out methodology to divide available ultrasound images into groupings to facilitate model training and validation based at least in part on the location of the scan site.

18. The system according to claim 16, where the sequence of instructions further including using an object detection model to identify skeletal structure within the patient.

19. The system according to claim 16, further comprising a linear ultrasound probe and/or a curvilinear ultrasound probe in communication with the at least one memory.

20. The system according to claim 10, further comprising during training using a leave-one-subject-out methodology to divide available ultrasound images into groupings to facilitate model training and validation based at least in part on the location of the scan site.

21. The system according to claim 10, where the sequence of instructions further including using an object detection model to identify skeletal structure within the patient.

22. The system according to claim 10, further comprising a linear ultrasound probe and/or a curvilinear ultrasound probe in communication with the at least one memory.
